(19) United States
(12) Patent Application Publication
(10) Pub. No.: US 2009/0204938 A1
(43) Pub. Date: Aug. 13, 2009

(54) SYSTEM AND METHOD FOR SYSTEMATICALLY ARRANGING A SET OF DISPLAY ELEMENTS IN ASSEMBLAGES TO MEANINGFULLY REPRESENT DATA

(75) Inventors: Mark Byron Schindler, Cambridge, MA (US); Angela Barbara Shen-Hsieh, Cambridge, MA (US); Scott Listfield, Somerville, MA (US)

Correspondence Address: DLA PIPER LLP US, P. O. BOX 2758, RESTON, VA, 20195, US

(73) Assignee: Visual I/O

(21) Appl. No.: 11/662,588

(22) PCT Filed: Feb. 3, 2005
(86) PCT No.: PCT/US05/03320

§ 371 Date: Feb. 10, 2009

Related U.S. Application Data
(60) Provisional application No. 60/609,824, filed on Sep. 15, 2004.
(60) Provisional application No. 60/617,194, filed on Oct. 12, 2004.

(51) Int. Cl. G06F 3/048; G06F 9/44

(52) U.S. Cl. 717/105; 715/763

(57) ABSTRACT

A system, method and computer program for creating a software application specification, including arranging graphical elements to form assemblages including information displays of the graphical elements. The assemblages are classified along a layout type dimension, and a relationship metaphor dimension, are specified by attributes of a situation being studied, and are respectively associated so as to describe a behavior of the graphical elements, a software application specification is generated based thereon. Further embodiments display graphical elements, corresponding to a feature set based on a matrix, a list, a collection, a curve, a timeflow, a sequence flow, a relationship, a map, a stack or a control and a feature set based on a situation of interest, a goal, a plan, a comparison, an evaluation, a conceptual aid, a qualifier, an action, an alert or an alarm, in a consistent manner to represent information in a form useful for decision-making or problem-solving.

### CROSS REFERENCE TO RELATED DOCUMENTS

The present invention claims benefit of priority to U.S. Provisional Patent Application Ser. No. 60/609,824 to Mark SCHINDLER, entitled “METHOD AND APPARATUS FOR COMPILING AND DISPLAYING DATA,” filed Sep. 15, 2004, and to U.S. Provisional Patent Application Ser. No. 60/617,194 to Mark SCHINDLER, et al., entitled “DECISIONCORE,” filed Oct. 12, 2004, the entire disclosures of all of which are hereby incorporated by reference herein.

### BACKGROUND OF THE INVENTION

1. Field of the Invention

The present invention generally relates to the field of computer graphics displays, and more particularly to a method and system for creating information system user interfaces that graphically display data in ways that are meaningful and useful. The present invention can employ technologies as referenced throughout the specification with numerals in brackets [ ] and listed and as cross-referenced in the LIST OF REFERENCES, the entire disclosures of all of which are hereby incorporated by reference herein.

2. Discussion of the Background

During the last quarter-century, businesses and other organizations have expended great efforts to capture, store and archive data they believe will be useful and valuable. In a world where computer processing and storage resources have traditionally been scarce, the challenge of information storage and retrieval has been treated as more of a technical problem than one driven by the needs of humans to understand the data. Accordingly, data has often been made available from information systems in ways that simply reflect the format in which it happened to be stored. Such conventional displays fail to give people enough context and perspective to allow them to take full advantage of the data.

Graphs, charts and diagrams have long been used to help make information more understandable and put data in context. More recently, the field of data visualization has applied computerized techniques to display information in more sophisticated and dynamic ways. Despite these recent innovations, however, methods for selecting an appropriate data visualization metaphor, from among all the possibilities, to meaningfully convey complex sets of data relationships to a human have not been developed beyond relatively simple relationships. Jock Mackinlay and others have proposed methods to automate graphic presentation of information. Mackinlay's approach [1] classified presentation techniques in terms of types of data relationships, and did not attempt to deal with meaning beyond the effectiveness of the representation. Others who followed (e.g., Roth and Mattis [2]) extended Mackinlay's model by incorporating user goals into the cataloging and classification of visualization types, for example the task analysis approach of Casner [3]. Wehrend and Lewis [4] have probably gone the furthest, by classifying visualization techniques by objects (data attributes) and operations (simple relations). These general-purpose approaches, and more recent work, have not significantly extended the field beyond matching of relatively simple relations and data types with appropriate chart types. Wehrend and Lewis acknowledged the limitations of these elemental approaches by observing that “real problems nearly always involve many kinds of objects and multiple user goals” [4, p. 141] and note that complex real-world problems often need be broken into sub-problems, which can not easily be recombined into integrated, consistent views of a complex situation.

In practice, the market for data visualization tools has been split between graphing toolkits that often provide dozens of standard chart types, and all-purpose visualization tools marketed as data browsing solutions suitable for a wide range of data representation needs. Still, difficulties remain for people wishing to gain a clear and consistent understanding of contextualized information relevant to everyday decisions and business problems.

Consider, for example, trying to compare several investments that each require upfront expenditures for a less than 100% potential of larger returns sometime in the future. Even in this relatively simple example, the units of currency, time, and uncertainty, combined with a range of possible outcomes, create a situation that will be difficult for many people to understand via tabular or conventional/elemental graphic representations (bar chart, scatter plot etc.).

In other cases, the sheer volume of information is so overwhelming—100,000 matches to an internet search query, for example, or tens of thousands of things for sale on an online auction site that match a selected keyword—that to find the thing one is looking for, and which one suspects is out there, requires endless scrolling and visual scanning, often to no avail.

Over the last few decades, decision scientists have gained a better understanding of how people use frames of reference to process information in the course of making decisions and solving problems. These findings have highlighted the roles of pattern recognition, mental simulation, reference points, yardsticks, metaphors and the like. While these findings suggest the value of consistent, systematic display metaphors, this thinking does not appear to have significantly influenced the way “decision-support” user experiences are structured.

Perhaps the most concerted efforts to try to provide useful information displays that meet human needs have come from the Human Computer Interaction field and usability, or human-centered design approaches. Using ethnographic and anthropological research methods to gain a deep understanding of the user, these approaches have helped software designers better understand the people who will use their user-interfaces. While this has helped eliminate many egregious usability difficulties in user-interface (UI) design, these approaches have disappointingly failed to help designers come up with more effective models for interacting with information. The movement has lately been criticized for stifling innovation in the UI and “blinkering designers' views of possible solutions.”

So while raw material useful to generating better human understanding of data now exists—in the form of charting metaphors and flexible technologies for graphical display and user interaction—what has not heretofore been provided is a way to consistently and systematically convert data into forms that are conducive to human understanding.

### SUMMARY OF THE INVENTION

Therefore, there is a need for a method and system that addresses the above and other problems. The above and other problems are addressed by the exemplary embodiments of the present invention, which provide a way for information to be automatically organized in display formats and metaphors that are appropriate to the needs of the person seeking the information. The viewer is thereby able to see information in a form that helps him or her see useful relationships in the data so as to better understand and act on that information in a problem-solving or decision-making context. The exemplary embodiments address the limitations of previous efforts (e.g. to catalog and automate the creation of visualization techniques) by considering the set of relations relevant to decision steps within a standard decision model (e.g., a Normalized Decision Model). Instead of trying to capture every type of possible information relationship within an elemental framework, the exemplary embodiments permit a smaller number of decision-relevant relationships to be addressed in more wholistic and detailed ways. In contrast to user-interfaces which provide a completely different metaphor—table, chart, etc.—with each view, or which aggregate numerous charts on a page, the exemplary embodiments apply graphical techniques of information display in consistent, systematic and integrated ways to make it less disorienting for users to get multiple perspectives and frames of reference on the data and relationships being displayed.

Accordingly, in exemplary aspects of the present invention there is provided a system, method, and computer program product for - - - , including [ATTORNEY FILLS IN THIS SECTION BASED ON FINAL CLAIMS]

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary overview of the processes, methods and frameworks comprising the invention;

FIG. 2 illustrates an exemplary description of the Decision Map Method and Process;

FIG. 3 illustrates an exemplary description of the Normalized Decision Model (NDM);

FIG. 4 illustrates an exemplary description of sub-components Monitor and Experience/Trigger of the NDM;

FIG. 5 illustrates an exemplary description of sub-component Assess of the NDM;

FIG. 6 illustrates an exemplary description of sub-component Model of the NDM;

FIG. 7 illustrates an exemplary description of sub-component Evaluate of the NDM;

FIG. 8 illustrates an exemplary description of sub-components Decide and Implement of the NDM;

FIG. 9 illustrates an exemplary description of the method by which a step in a mapped decision process is linked to a corresponding BRM and SPF attributes;

FIG. 10 illustrates another exemplary description of the method referenced in FIG. 9;

FIG. 11 illustrates an exemplary description of the method by which a step in a mapped decision process is linked to a corresponding Assemblage Organization Metaphor type and Visualization Assemblage Type;

FIG. 12 illustrates an exemplary description of the Situation Perspective Framework (SPF);

FIG. 13 illustrates an alternative embodiment of the Situation Perspective Framework (SPF), showing Situation details/context, Situation Datastreams, and Situation Time Structures matrixed with Situation perspectives;

FIG. 14 illustrates an exemplary description of the Business Relationship Metaphors (BRM);

FIG. 15 illustrates an exemplary description of the Assemblage Organization Metaphors (AOM);

FIGS. 16A, B and C illustrate an exemplary set of Visualization Assemblages, organized by BRM and AOM;

FIG. 17 illustrates an exemplary description of the method and process by which additional assemblages are incorporated into the Solution Asset Set;

FIG. 18 illustrates an exemplary description of a solution application—DecisionCore;

FIG. 19 illustrates an exemplary description of a solution application—Iris;

FIG. 20 illustrates an exemplary description of a solution application—Hierarchy Browser;

FIG. 21 illustrates an exemplary description of a solution application—Value Machine;

FIG. 22 illustrates a summary of the views (assemblages) and components that comprise an exemplary DecisionCore solution application;

FIG. 23 illustrates an exemplary summary of the view features in a DecisionCore solution application;

FIG. 24 illustrates a bubble chart by phase/category, an exemplary view assemblage from a DecisionCore solution application;

FIG. 25 illustrates a bubble chart by value/risk, an exemplary view assemblage from a DecisionCore solution application;

FIG. 26 illustrates a project timeline view by phase, an exemplary view assemblage from a DecisionCore solution application;

FIG. 27 illustrates a project timeline view by value/investment, an exemplary view assemblage from a DecisionCore solution application;

FIG. 28 illustrates a project timeline view by resource consumption, by skill type, an exemplary view assemblage from a DecisionCore solution application;

FIG. 29 illustrates a project timeline view by resource consumption, by probability, an exemplary view assemblage from a DecisionCore solution application;

FIG. 30 illustrates a project timeline view by project risk history, an exemplary view assemblage from a DecisionCore solution application;

FIG. 31 illustrates a project timeline view by project risk history, an exemplary view assemblage from a DecisionCore solution application;

FIG. 32 illustrates a pipeline flow view, an exemplary view assemblage from a DecisionCore solution application;

FIG. 33 illustrates part of a pipeline flow view, an exemplary view assemblage from a DecisionCore solution application;

FIG. 34 illustrates a project list view, an exemplary view assemblage from a DecisionCore solution application;

FIG. 35 illustrates a project list view, showing projects grouped by a project category, an exemplary view assemblage from a DecisionCore solution application;

FIG. 36 illustrates a risk heatmap, an exemplary view assemblage from a DecisionCore solution application;

FIG. 37 illustrates a collaborative risk/value modeler, an exemplary view assemblage from a DecisionCore solution application;

FIG. 38 illustrates an exemplary scenario builder, an exemplary view assemblage from a DecisionCore solution application;

FIG. 39 illustrates a pipeline output assemblage, an exemplary view assemblage from a DecisionCore solution application;

FIG. 40 illustrates exemplary budget vs. spend, and resource vs. capacity, exemplary view assemblages from a DecisionCore solution application;

FIG. 41 illustrates exemplary resource vs. capacity view assemblages, showing the effect of a confidence level slider, exemplary assemblages from a DecisionCore solution application;

FIG. 42 illustrates exemplary capacity opportunity areas on a resource vs. capacity view, an exemplary view assemblage from a DecisionCore solution application;

FIG. 43 illustrates an exemplary solution map schematic from an exemplary DecisionCore solution application;

FIG. 44 illustrates an alternate embodiment of a project timeline view by phase, an exemplary view assemblage from a DecisionCore solution application;

FIG. 45 illustrates an alternate embodiment of a pipeline flow, an exemplary view assemblage from a DecisionCore solution application;

FIG. 46 illustrates an alternate embodiment of a project list view, an exemplary view assemblage from a DecisionCore solution application;

FIG. 47 illustrates an exemplary project timeline view by resource consumption, showing how dragging one of the project assemblages to a new date produces a recalculation of the resources and capacity;

FIG. 48 illustrates an exemplary filter assemblage, as part of an exemplary Iris solution application;

FIG. 49 illustrates alternate example states of an exemplary Iris results assemblage;

FIG. 50 illustrates exemplary elements of a results assemblage, as part of an exemplary Iris solution application;

FIG. 51 illustrates other examples of results assemblages, as part of an exemplary Iris solution application;

FIG. 52 illustrates exemplary features of a detail window assemblage, as part of an exemplary Iris solution application;

FIG. 53 illustrates an exemplary view from an Iris solution application, showing coloring/shading of results elements by priority;

FIG. 54 illustrates an exemplary view from an Iris solution application, showing coloring/shading of results elements by category or other attributes;

FIG. 55 illustrates an exemplary view from an Iris solution application, showing a radial iris type results assemblage, and coloring/shading of results elements by priority;

FIG. 56 illustrates an exemplary view from an Iris solution application, showing a list type results assemblage, and coloring/shading of results elements by priority;

FIG. 57 illustrates an exemplary view from an Iris solution application, showing a timeflow-type results assemblage, and coloring/shading of results elements by priority;

FIG. 58 illustrates an exemplary view from an Iris solution application, showing coloring/shading of results elements by intensity of match with a single filter type;

FIG. 59 illustrates an exemplary Iris results assemblage, showing coloring/shading of results by a variable value;

FIG. 60 illustrates an exemplary Iris results assemblage, in radial Iris format;

FIG. 61 illustrates an exemplary Iris results assemblage in radial Iris format, showing an exemplary detail mouseover for a result element;

FIG. 62 illustrates an exemplary Iris results assemblage in radial Iris format, showing an exemplary overlay to represent hierarchical relationships among the results elements;

FIG. 63 illustrates an exemplary Iris results assemblage in radial Iris format, showing a single radial assemblage disassembled into multiple assemblages, each one representing a sub-category of the original assemblage;

FIG. 64 illustrates the same exemplary assemblage as in FIG. 64, except with a range of criteria highlighted;

FIG. 65 illustrates an exemplary view of an Iris solution application, showing the results window in a timeline metaphor and the detail window displaying detail for a single element in the results window;

FIG. 66 illustrates an exemplary view of an Iris solution application, showing the same dataset as in FIG. 65, but with an alternate exemplary coloring scheme for the results window;

FIG. 67 illustrates an exemplary view of an Iris solution application, showing the same dataset as in FIG. 65, but with the results window displaying in a list, rather than timeline, metaphor;

FIG. 68 illustrates an exemplary view of an Iris solution application, showing a particular set of relationships among a group of elements returned from a query or filterset;

FIG. 69 illustrates an exemplary view of an Iris solution application, showing the same dataset as in FIG. 68, but with the results window shown in a timeline metaphor instead of a list;

FIG. 70 illustrates an exemplary view of an Iris solution application, showing results window elements in a radial format;

FIG. 71 illustrates an exemplary Hierarchy Browser stack, in one sample state;

FIG. 72 illustrates an exemplary view from a Hierarchy Browser solution application;

FIG. 73 illustrates an exemplary view of a Hierarchy Browser solution application, with each stack representing the same dataset filtered in different ways;

FIG. 74 illustrates an exemplary view of a Hierarchy Browser solution application, in a mode whereby user selection of a stack segment causes highlighting, rather than filtering of datasets as they are passed to subsequent stacks;

FIG. 75 illustrates an exemplary view of a Hierarchy Browser solution application, showing an example of how a stack may be dragged by a user to a new location within the stack order;

FIG. 76 illustrates an exemplary view of a Hierarchy Browser solution application, showing an example result of the dragging operation illustrated in FIG. 75;

FIG. 77 illustrates an exemplary view of a Hierarchy Browser solution application, showing examples of various selection and highlighting actions;

FIG. 78 illustrates an exemplary view of a Hierarchy Browser solution application, showing an example use of a filter window to determine the initial dataset loaded into the stacks;

FIG. 79 illustrates an exemplary view of a Hierarchy Browser solution application, showing examples of filtering and highlighting in the stacks area, and an example of multiple levels of detail within the Results & detail area;

FIG. 80 illustrates an exemplary assemblage from a Value Machine solution application, showing the elements of a value channel;

FIG. 81 illustrates an exemplary view of a Value Machine solution application, showing value channels rolled-up into aggregate inflows and aggregate outflows; and

FIG. 82 illustrates an exemplary view of a Value Machine solution application, showing an example of a workspace area opened to display a value channel in context of the aggregated channels.

### DETAILED DESCRIPTION OF THE PREFERRED EMBODIMENTS

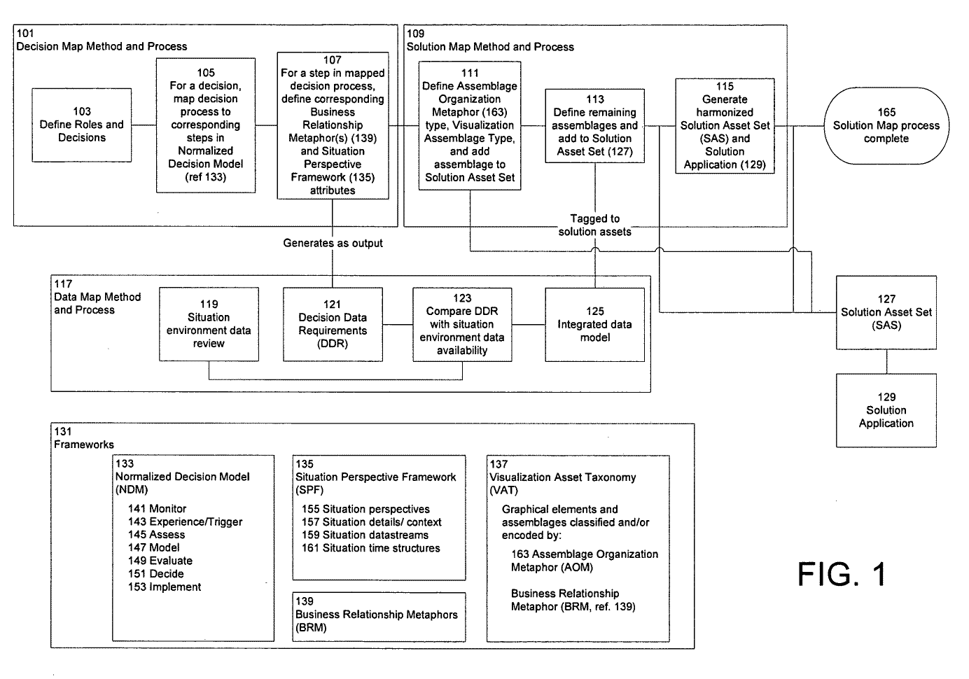

Referring now to the drawings, wherein like reference numerals designate identical or corresponding parts throughout the several views, and more particularly to FIG. 1 thereof, there is illustrated an exemplary overview of the processes, methods and frameworks comprising the invention according to an exemplary embodiment. In FIG. 1, four frameworks are provided within element 131:

Visualization Asset Taxonomy, or VAT, (element 137) comprising groups of graphical elements arranged in different layouts and formats, each such assemblage classified along at least two dimensions: (1) layout type (“Assemblage Organization Metaphor,” or AOM, ref 163), and (2) relationship metaphor (“Business Relationship Metaphor,” or BRM, ref 139). Each assemblage may be further specified by attributes of the situation being studied. Those attributes are described in the Situation Perspective Framework (SPF, see below). Assemblages may be encoded with method(s) that describe the behavior (e.g., positioning, movement, coloring, shading, size etc.) of the graphical elements contained within the assemblage. Features of the VAT include:

A set of graphical elements, which may be arranged or assembled in different formats, configurations, orientations etc. to comprise one or more information displays (assemblages). These graphical elements include—but are not limited to—such things as rectangles, circles, ellipses, lines, raster images, curves, freeform shapes, symbols, text (e.g., as labels or blocks of text), icons etc.

A set of design variables which may be applied to any of the appropriate graphical elements. These include, but are not limited to, such variables as color of the object, shading of object, transparency, contrast or brightness, bordering line weight, line color, size, dimension(s) or rotation of element, etc.

A set of combination metaphors for arranging the graphical elements in a display layout.

A standard decision model (“Normalized Decision Model”, or NDM, ref 133), to which any decision or problem-solving process in the real world may be mapped. Its high level steps include: Monitor (141), Experience/Trigger (143), Assess (145), Model (147), Evaluate (149), Decide (151), Implement (153). Each high level step may contain detail steps. Detail decision steps may be linked to one or more BRMs.

A framework (“Situation Perspective Framework,” or SPF, 135), which includes: (a) Situation perspectives (155), (b) Situation details/context (157), (c) Situation datastreams (159), and (d) Situation time structure (161).

Business Relationship Metaphor, or BRM framework (139) is a taxonomy of business relationships.

FIG. 1 also illustrates an exemplary method and process (Decision Map, 101), which correlates the steps of any decision or problem-solving process with those of the NDM, links one or more so-correlated steps with one or more BRMs, and tags the step(s) with attributes from the SPF. A method and process (Data Map, 117) links an assemblage type specified by the Decision Map to situation environment data source(s) to generate an integrated data model. A method and process (Solution Map, 109) takes a decision step (or steps) that has been linked to NDM steps, BRM(s) and SPF attributes (as by Decision Map process) and links it to a specified AOM and assemblage type (or types) in the VAT, incorporates these and additional assemblages into a “Solution Asset Set,” or SAS, incorporates an integrated data model, and links the SAS assemblages into a “Solution Application” (129). A method or collection of methods, “Solution Application,” comprises a set of linked assemblages resulting from application of a Decision Map and Data Map process.

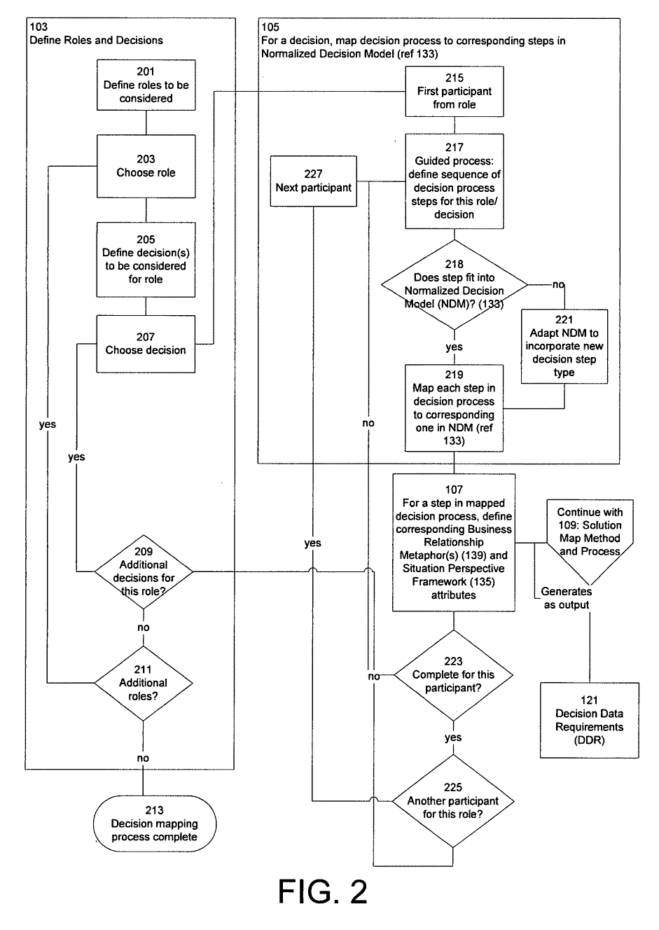

FIG. 2 illustrates an exemplary description of the Decision Map Method and Process (101). Participants in a set of related decision processes are grouped into roles. Once these roles are defined (201), the decision processes in which each role participants are defined (205) and then mapped to standard steps in the NDM (219). If the NDM does not have a standard step in its model to accept a decision step being mapped, the NDM may be expanded or modified accordingly (221). Several people representing a single role (225) may participate in the process. This additional input may provide a fuller set of examples by which to build the decision map and the Solution Application.

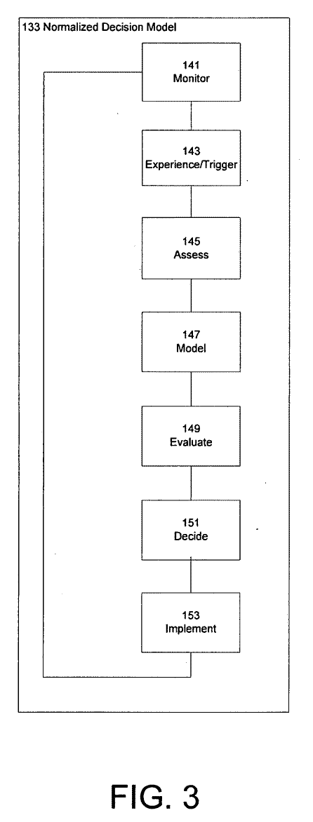

FIG. 3 illustrates an exemplary description of the Normalized Decision Model (NDM) (133) showing the high-level steps.

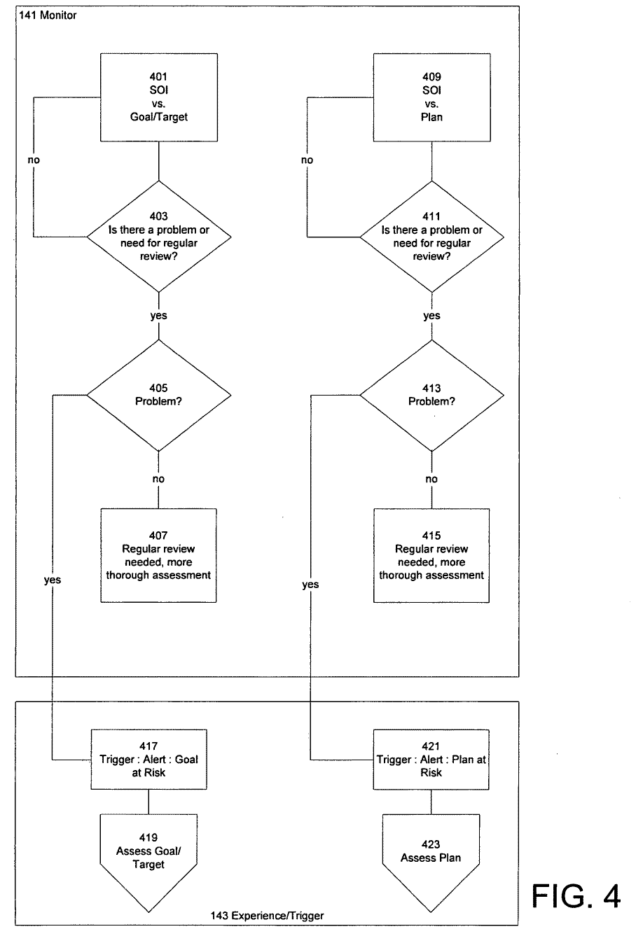

FIG. 4 illustrates an exemplary description of sub-components Monitor (141) and Experience/Trigger (143) of the NDM (133). Monitor is the state of awareness whereby a decision-maker is assessing whether the situation of interest (SOI, the situation around which the decision process is focused), as it is developing in time, is consistent with plans and on track to meet goals. An example would be checking to be sure a project (the SOI in this case) is on-time and meeting agreed-upon milestones. Monitor also indicates the everyday state people are in when they are not solving a problem or deciding. Experience/Trigger indicates an event or experience that triggers a decision process. For example, a traffic light turning yellow may be a trigger to decide whether to speed up through an intersection or stop.

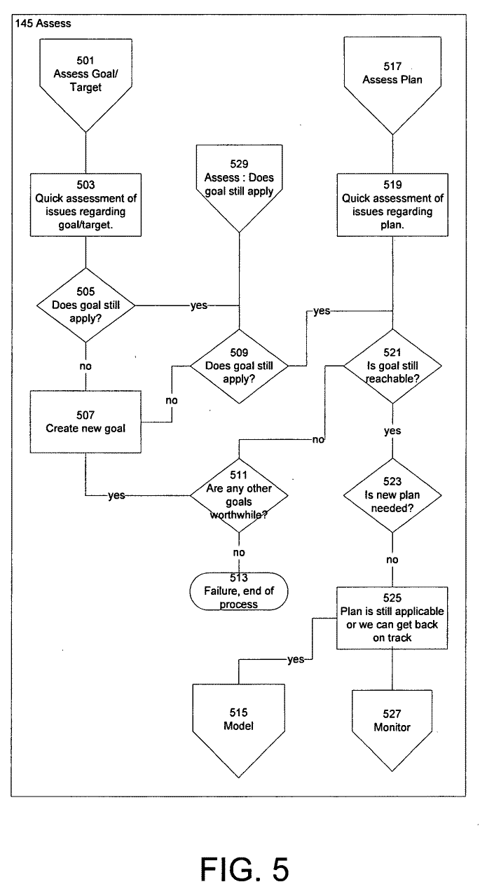

FIG. 5 illustrates an exemplary description of sub-component Assess (145) of the NDM (133). Assess is the process of understanding a situation to determine whether action is necessary.

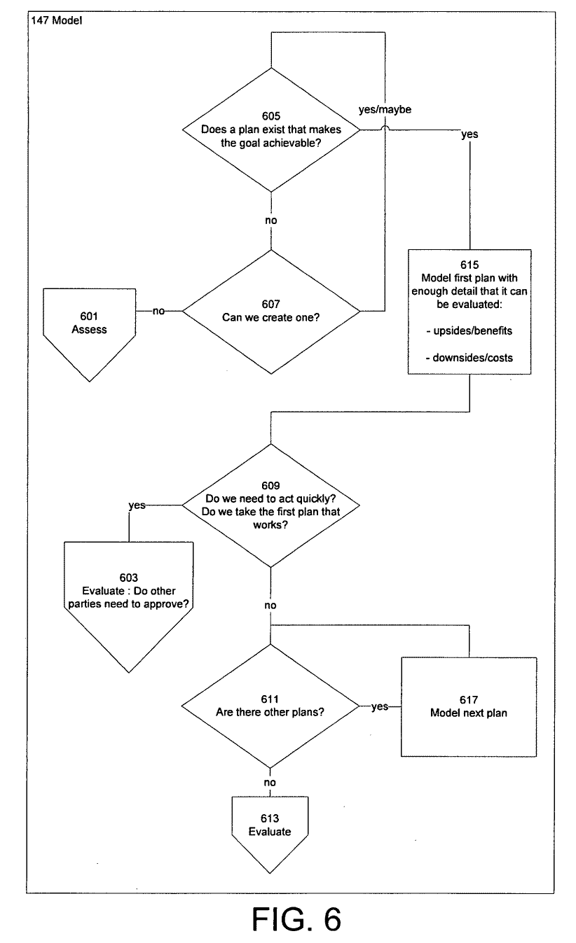

FIG. 6 illustrates an exemplary description of sub-component Model (147) of the NDM (133). Model is the process of considering several possible actions, or decision paths.

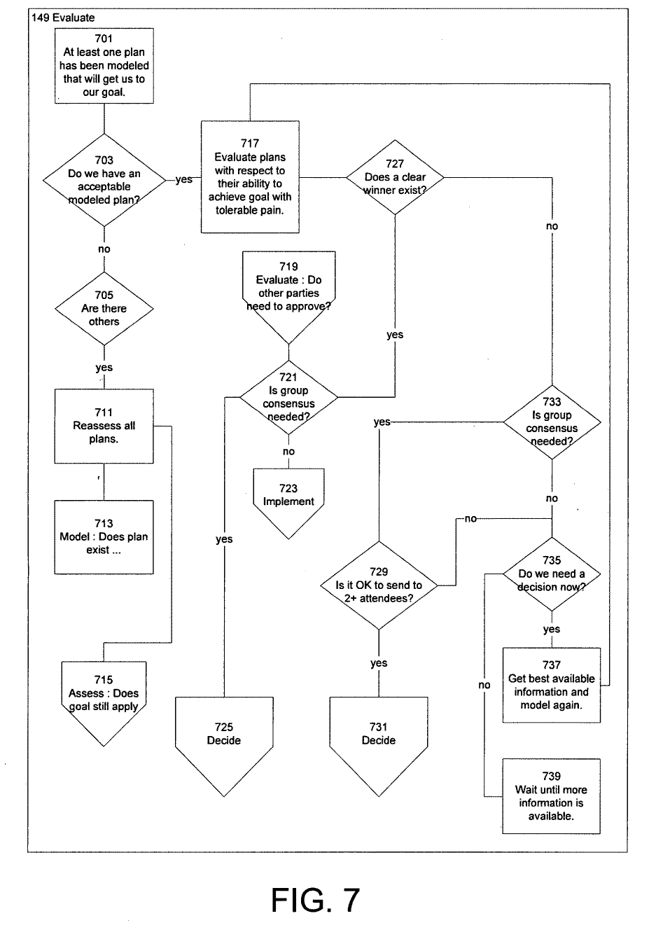

FIG. 7 illustrates an exemplary description of sub-component Evaluate (149) of the NDM (133). In this process, possible actions or decision paths are evaluated in terms of how likely they will be to achieve a goal, or whether the plan(s) they imply are acceptable or feasible. Potential actions or plans may be compared to one another to decide which one to choose.

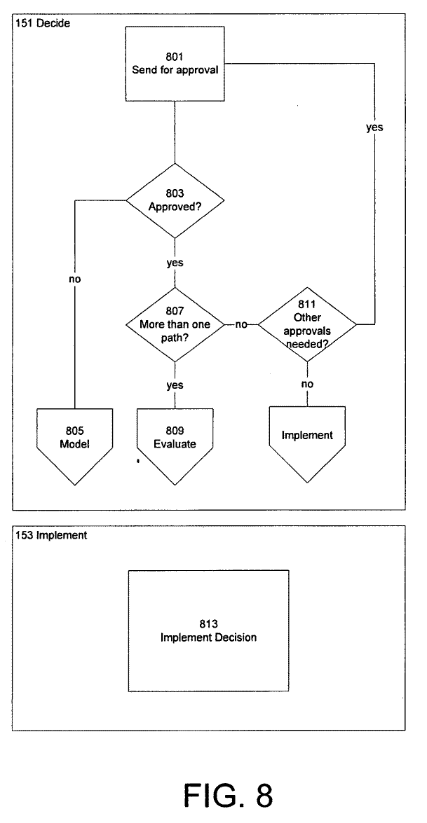

FIG. 8 illustrates an exemplary description of sub-components Decide (151) and Implement (153) of the NDM (133). They describe the process of making a decision and putting it into action.

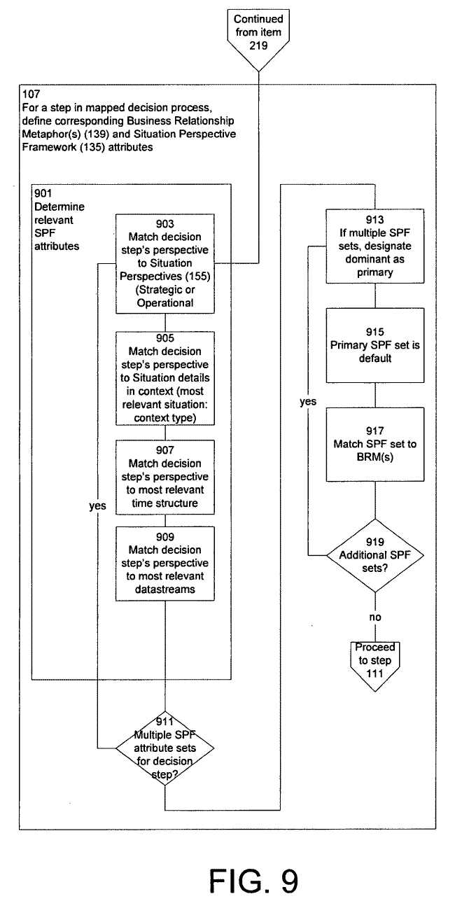

FIG. 9 illustrates an exemplary description of the method by which a step in a mapped decision process is linked to a corresponding BRM and SPF attributes (ref. 107). A set of logical steps channel the attributes of an exemplary decision step to determine which business relationships will help give perspective and useful form to information relevant at that step. Once the decision step is mapped on all relevant Situation Perspective Framework attributes, the resulting SPF sets are matched with the appropriate BRMs.

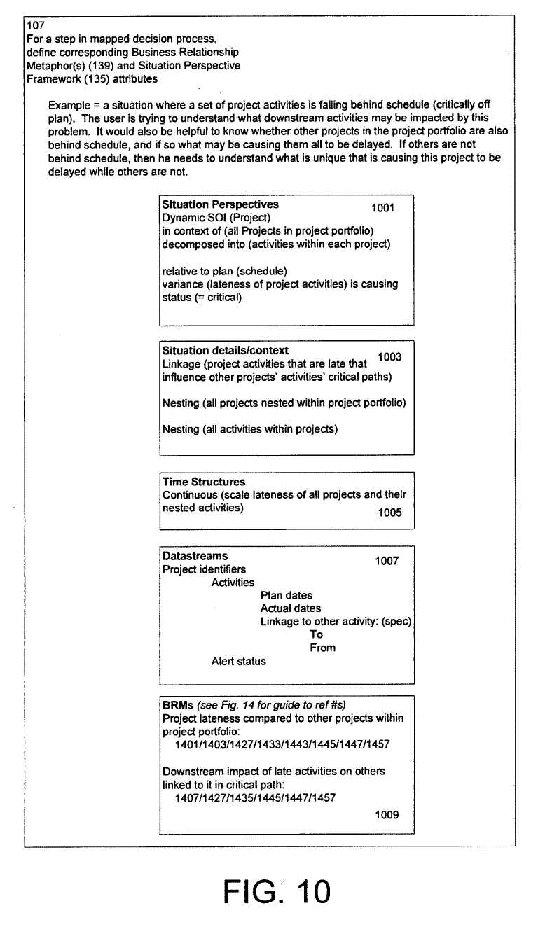

FIG. 10 illustrates another exemplary description of the method referenced in 107. An example decision step is mapped as illustrated in FIG. 9. In this example, a situation of interest (SOI)—a project—is being studied in two contexts: (1) its lateness in comparison to other projects in a project portfolio, and (2) its constituent elements—its project activities—in terms of what may be causing them to be late, and which downstream activities they may be linked with on a critical path.

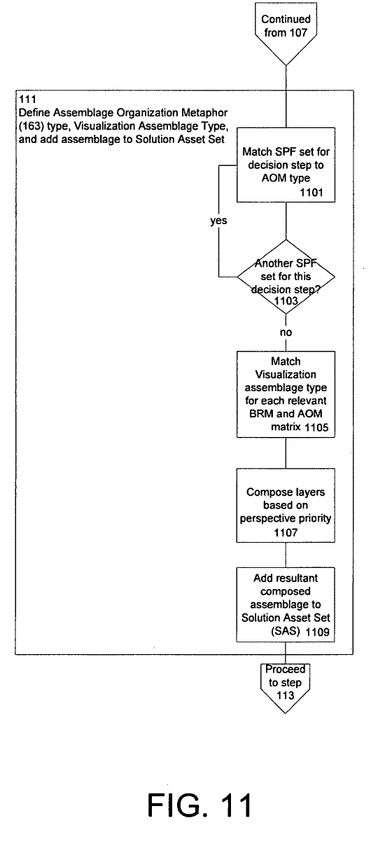

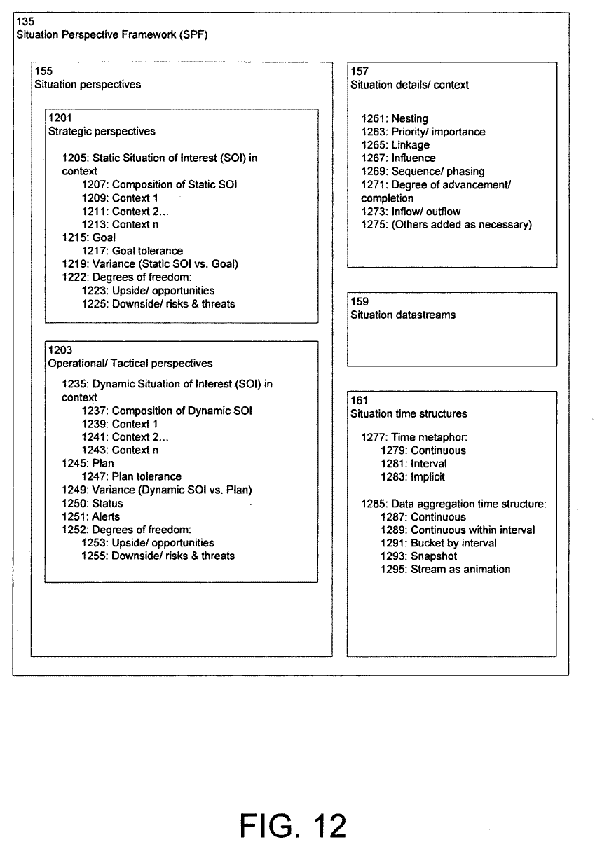

FIG. 11 illustrates an exemplary description of the method by which a step in a mapped decision process is linked to a corresponding Assemblage Organization Metaphor (163) type and Visualization Assemblage Type. A logical tree determines the most appropriate view layout metaphor, based on what is being studied at a decision step. For multiple perspectives, the primary perspective governs the base AOM and additional perspectives are layered on top.

FIG. 12 illustrates an exemplary description of the Situation Perspective Framework (SPF), (135). Decisions involve situations, goals and plans. A goal is a desired state, and a plan is an action or set of actions designed to achieve a goal. A situation can be understood and analyzed by modeling it in different contexts (e.g., environments or conceptual structures surrounding the situation) or by examining its constituent elements or attributes. Situations often have many different contexts within which they may be examined or analyzed: temporal contexts, geographical contexts, contexts whereby a situation may be compared with other similar situations, etc. Examples of situations, contexts and constituent elements/attributes are:

A student (situation of interest) in a classroom (context), characterized by his/her performance in different subjects (attributes).

An office building (SOI), its comparables on the rental real estate market (context 1), its historical profitability (context 2), its position within a portfolio of owned real estate assets (context 3), its tenants and leases (constituent elements/attributes).

A sales territory (SOI), all of the sales territories in the market (context 1), its historical performance (context 2), the group of sales reps serving the territory (elements 1), the customers in that territory (elements 2).

Goals (1215) and plans (1245) may have tolerances (1217, 1247)—a range of situation states considered to be “close enough.” Being only 2 days behind schedule, for example, or just slightly over budget, may not be cause for alarm or concern.

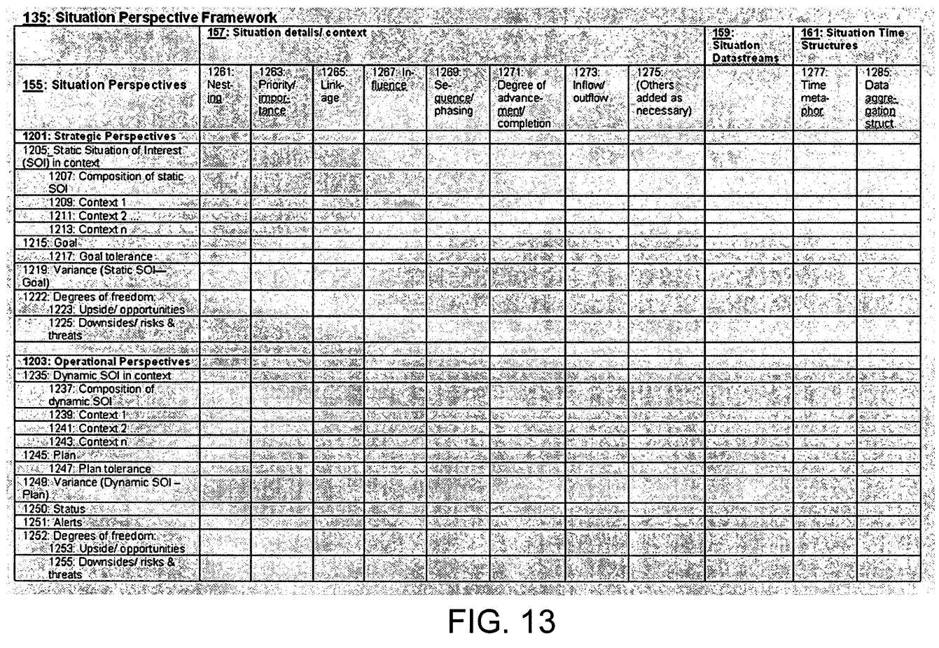

FIG. 13 illustrates an alternative embodiment of the Situation Perspective Framework (SPF)(135), showing Situation details/context (157), Situation Datastreams (159), and Situation Time Structures (161) matrixed with Situation perspectives (155). This format is useful to map how datastreams, time structures and different kinds of context or composition metaphors relate to the situation perspectives. For example, if the SOI is one step in a multi-step process, a context (1209) of the SOI may be well-characterized by the sequencing/phasing (1269) context type.

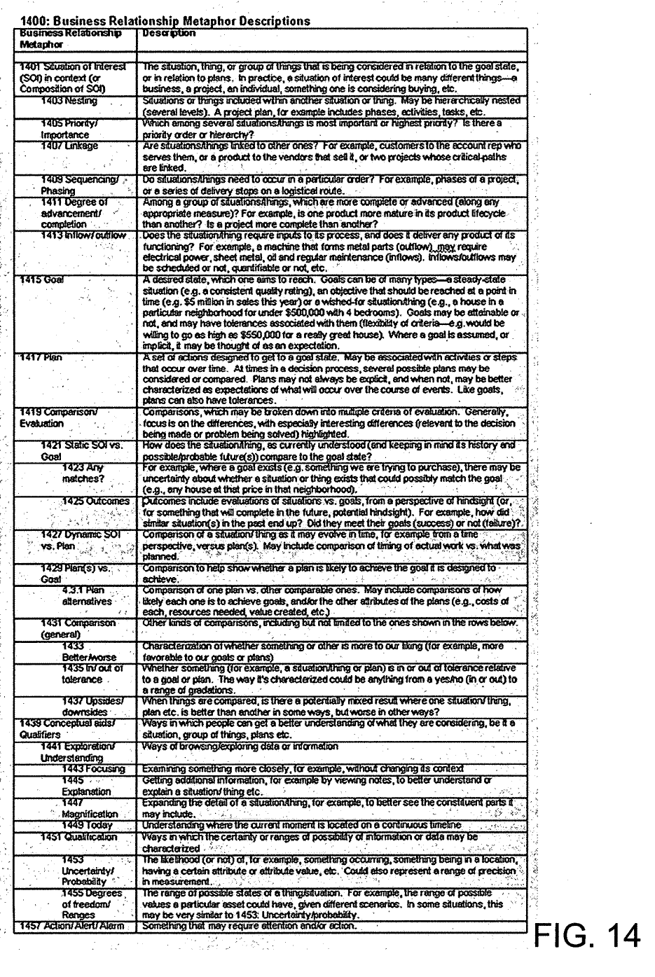

FIG. 14 illustrates an exemplary description of the Business Relationship Metaphors (BRM, ref. 139).

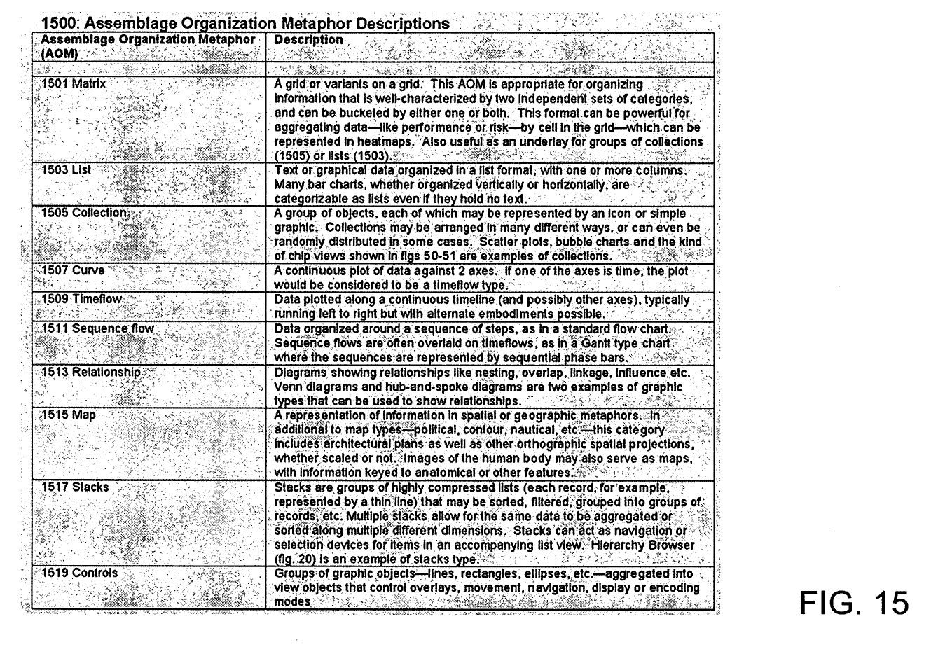

FIG. 15 illustrates an exemplary description of the Assemblage Organization Metaphors (AOM) (163).

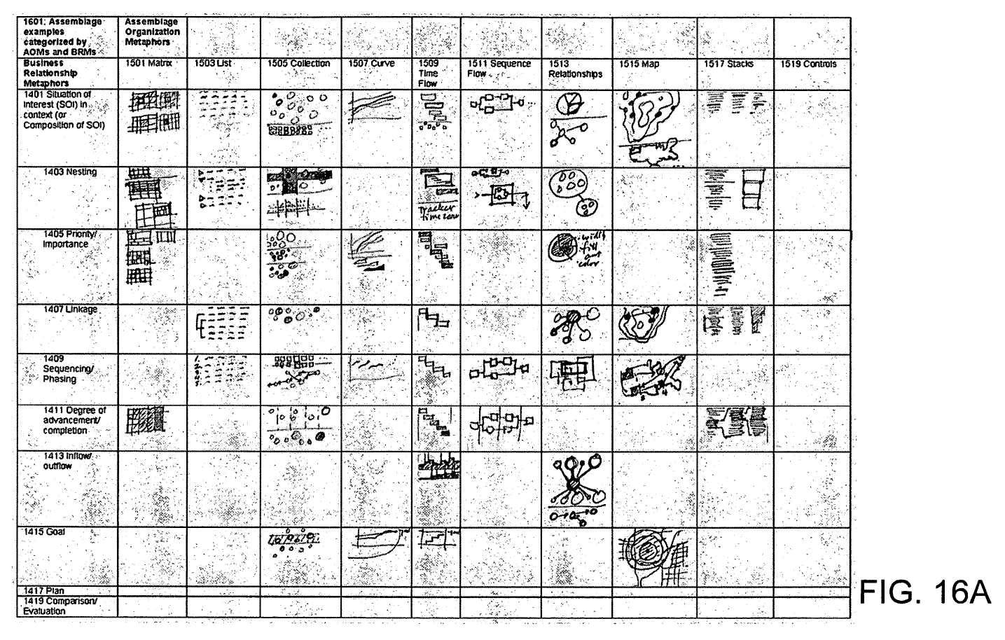

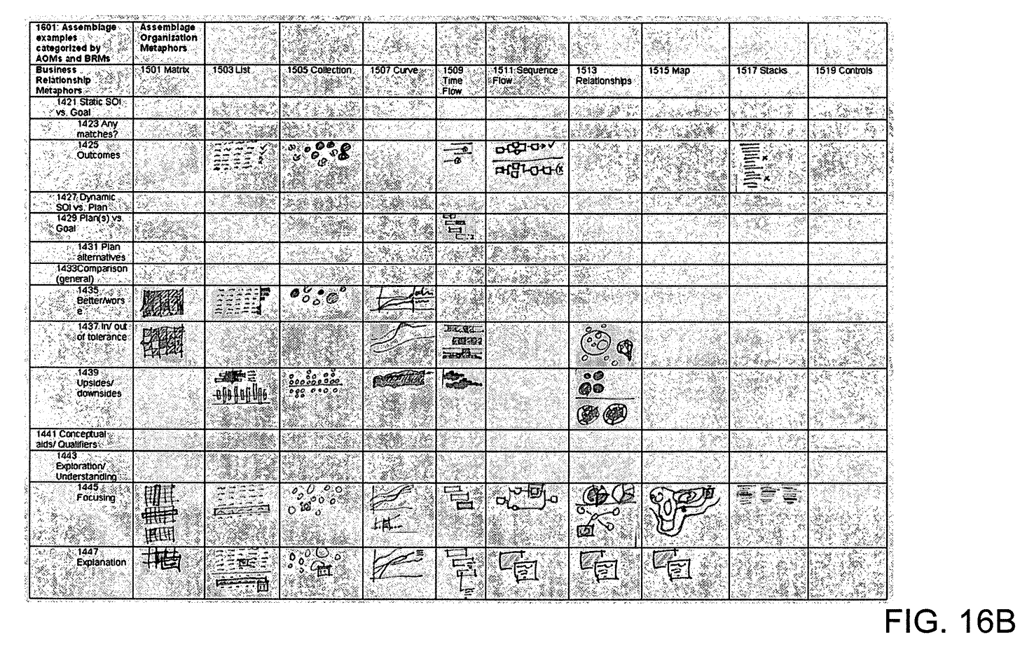

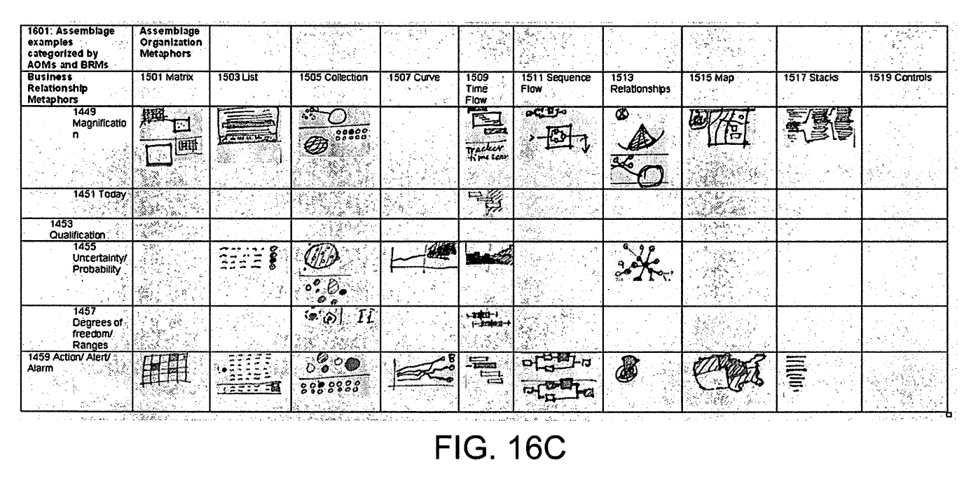

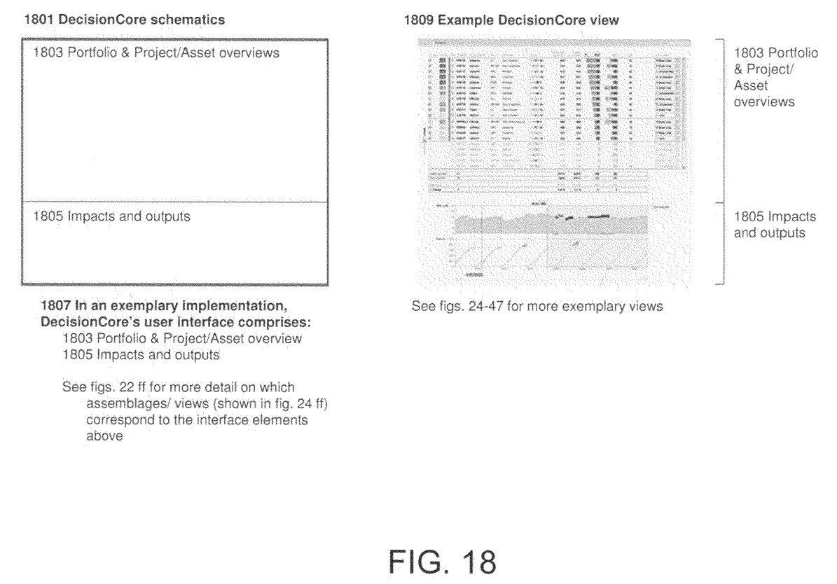

FIGS. 16A, B and C illustrate an exemplary set of Visualization Assemblages, organized by BRM and AOM. It is a subset of the Visualization assemblage metaphors included in the taxonomy. Graphical metaphors are used consistently to show BRMs across different AOM types. For example, the same red color shows a situation performing poorly (1433), regardless of which AOM it is displayed in. FIG. 16C illustrates several example assemblages for 1455: Uncertainty/Probability. Several exemplary graphical conventions are employed for this BRM—shading (darker or more opaque shade=more certain; lighter or more transparent=less certain). Other metaphors include (not shown in FIG. 16) larger size ring to indicate greater uncertainty, smaller size to indicate less uncertainty. Other examples of assemblage metaphors appear in the view examples below (see FIG. 18ff).

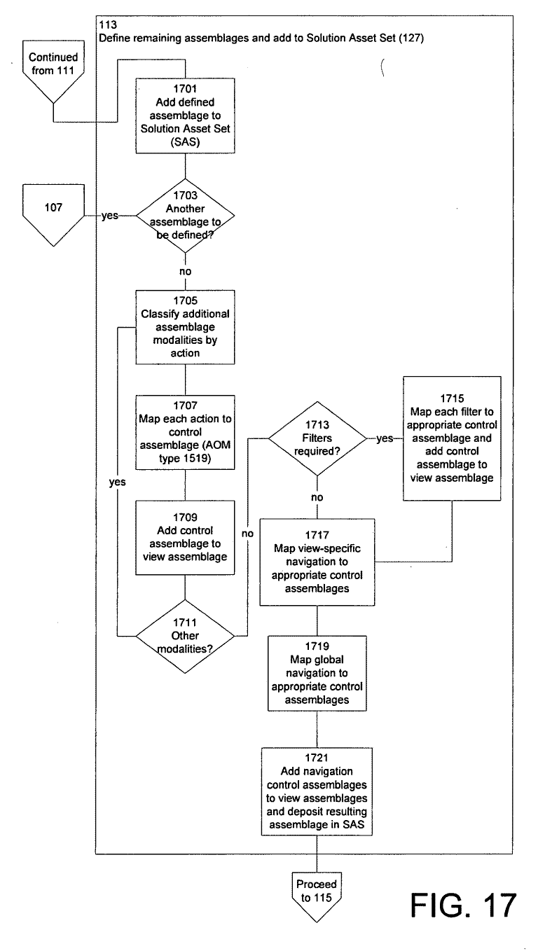

FIG. 17 illustrates an exemplary description of the method and process (cf. 113) by which additional assemblages are incorporated into the Solution Asset Set. Assemblages—in this case controls—to provide modality changes, layer changes, filters or navigation, are defined and added to the SAS.

FIG. 18 illustrates an exemplary description of a solution application (cf. 129)—DecisionCore. DecisionCore is comprised of a set of decision tools for maximizing the value and performance of a portfolio comprised of assets or projects. DecisionCore is oriented to management of portfolios whose assets or projects each have profiles of value, risk, and resource consumption over time. An example is a portfolio of Research & Development projects. Given a fixed set of organizational and external constraints (e.g., financial, human resource, scheduling and other), DecisionCore helps managers visualize the status of a portfolio, identify problems such as constrained capacity. Using various assemblages of visual assets and metaphors, DecisionCore helps people see the relationships between changes in the composition of the portfolio (e.g., including or excluding assets), or modifying asset options (e.g., invest more or less in an asset)—and high level portfolio metrics such as value, risk level, and cost/resources relative to budgets or capacity. DecisionCore functionality may be organized into modules, for example as follows: a module comprising project and portfolio tracking and analysis, a module comprising project and portfolio evaluation tools and a module for modeling and optimization of portfolio value within resource capacity constraints.

DecisionCore could be used to help address portfolio-related business problems and decisions, such as, for example: deciding whether to buy or license a new asset/project, deciding whether to discontinue work on a project, deciding whether (and when) to sell or outlicense an asset, prioritizing assets in terms of how much effort should be spent on each, evaluating different options for how a project should be moved forward, optimizing the value of a portfolio, given fixed resources and budgets, allowing a group of people to collaboratively assess risk and value for a particular asset, or comparing a project/asset to similar ones from the past, which helps identify possible problems or opportunities.

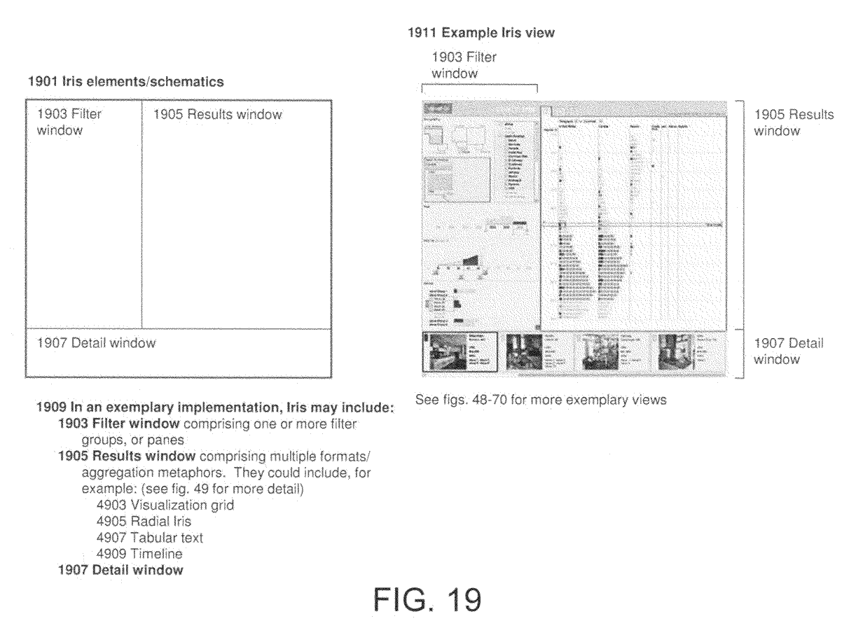

FIG. 19 illustrates an exemplary description of a solution application (cf. 129)—Iris. Iris is a visual search tool for interactive querying and visualization of results from structured and unstructured data. The user-interface is comprised of: a group of filters, (“Filter window”), an area where results from a search or database query may be displayed in different modes and formats/aggregation types (“Results window”), an area where a selection of results may be examined in more detail (“Detail Window”). Iris may be applied or used in many different ways and used for many different purposes. It could be used as a front end for just about any suitable structured database or data repository. In its various exemplary implementations, it could be useful for browsing products or offerings for sale/auction at commercial sites like Amazon.com or Ebay, or for more unstructured searches like Google's. When running against a continuous stream of (e.g. real time) data, Iris (or a minimized or compressed view mode of Iris, comprising for example the filter window) can be left open on a user's computer or information display all the time, and as data comes in that matches highlight/alert criteria, could produce a visual or audible alert for the user.

A few examples of uses, or applications, for Iris include: browsing Human resource information (e.g. employees in a worldwide database), legal caseload info, Entertainment and Restaurants (e.g., finding movies, music, etc., locating restaurants, etc.), locating houses/real estate for sale, photo databases (e.g. ethnographic documentation), sports data, project planning data (e.g. illustrating deliverables or other project assets), computer files and folders (e.g., as a way to return searches of a hard drive), visualizing emails, appointments and other calendar items, threat (or opportunity) detection (with, for example, a minimized window always on/open, could visualize and alert to threats or opportunities as they arise).

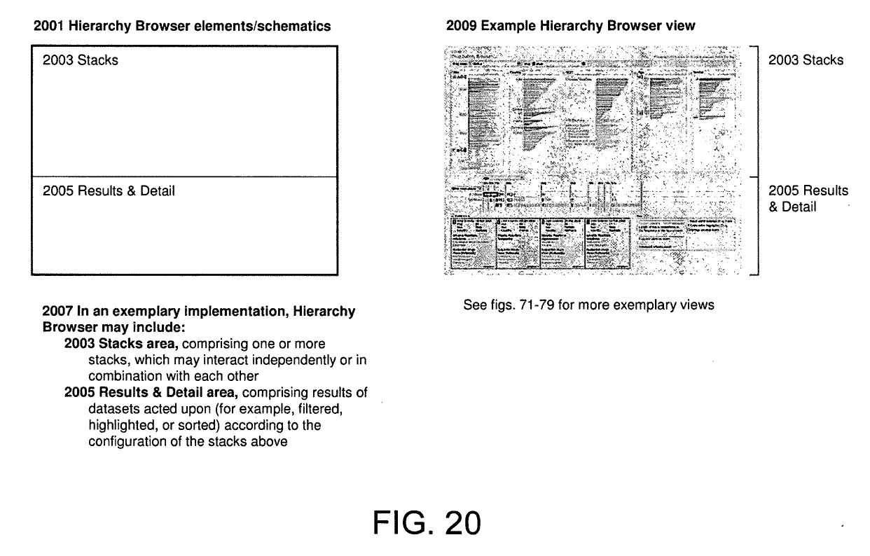

FIG. 20 illustrates an exemplary description of a solution application (cf. 129)—Hierarchy Browser.

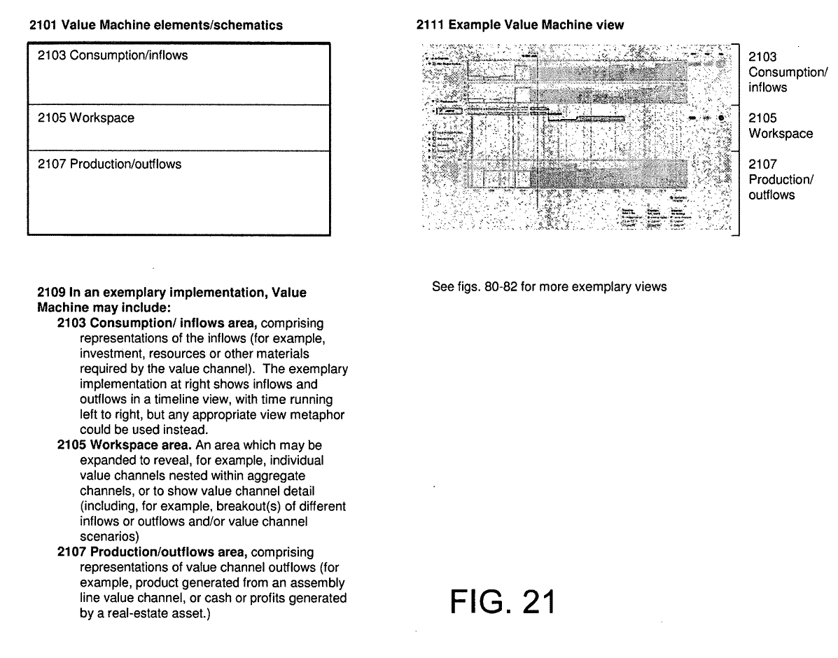

FIG. 21 illustrates an exemplary description of a solution application (cf. 129)—Value Machine.

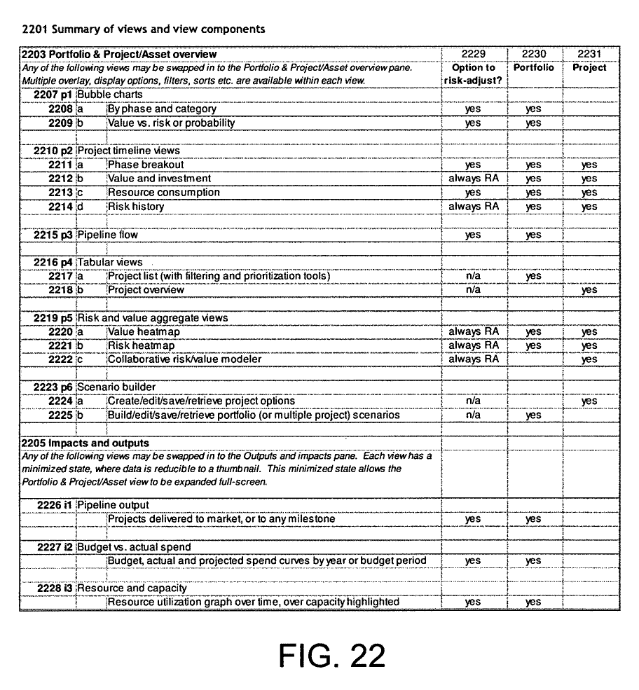

FIG. 22 illustrates a summary of the views (assemblages) and components that comprise an exemplary DecisionCore solution application.

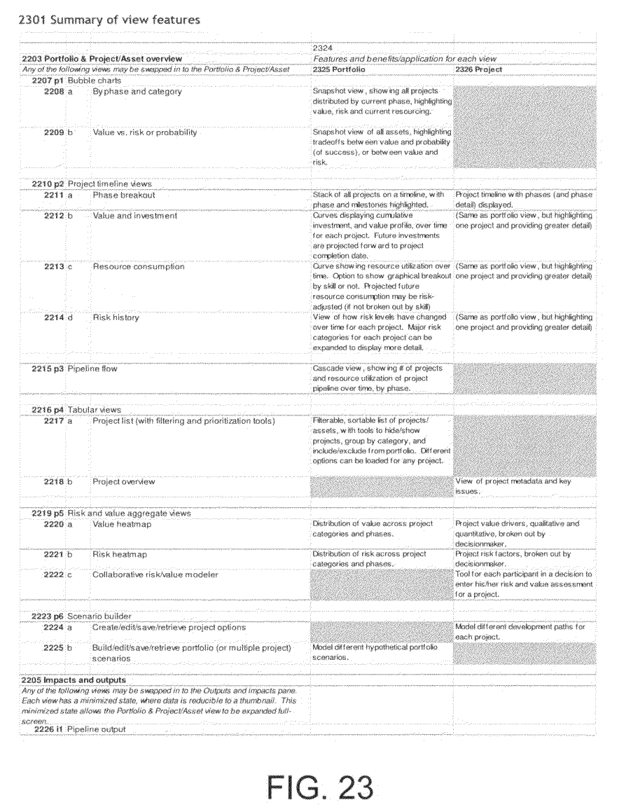

FIG. 23 illustrates an exemplary summary of the view features in a DecisionCore solution application.

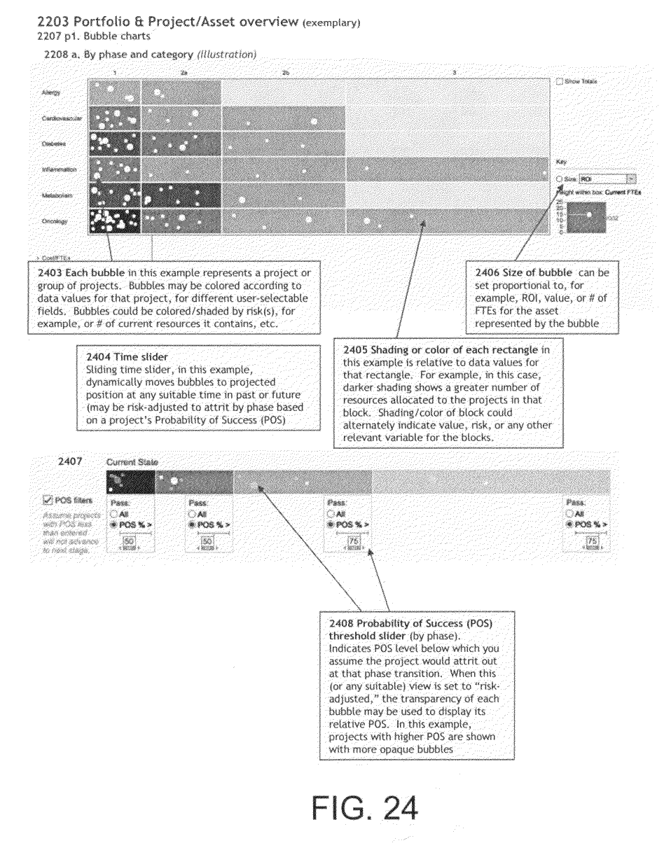

FIG. 24 illustrates a bubble chart by phase/category, an exemplary view assemblage from a DecisionCore solution application. This view is an example of a base layer comprised of AOM Matrix type/BRM type 1433 (Comparison: general). The grid, in this example, illustrates project phases (in columns) and project categories (in rows). Overlay perspectives include the bubble layer (AOM Collection type/BRM type 1433 (Comparison: general)). Further overlay modes at the bubble layer, for example, provide for BRM type 1435 (Comparison: better/worse), to show which projects are performing better or worse than expected, and BRM type 1459 (Action/Alert/Alarm) a mode which, when selected, in this example shows critical risks. Additional overlay perspectives, by mousing over a bubble, clicking a bubble, or sliding a time slider, provide, respectively, BRM 1447 (Explanation), BRM 1445 (Focusing) and BRM 1409 (Sequencing/phasing of dynamic SOI).

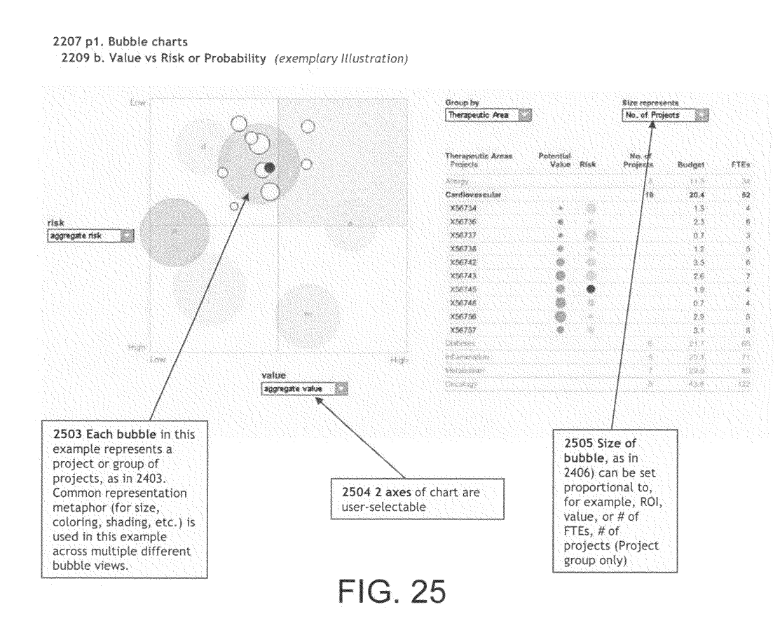

FIG. 25 illustrates a bubble chart by value/risk, an exemplary view assemblage from a DecisionCore solution application. In an exemplary implementation, BRMs provided on this view use the same graphical representation conventions as on FIG. 24, further leveraging the BRM metaphor across views.

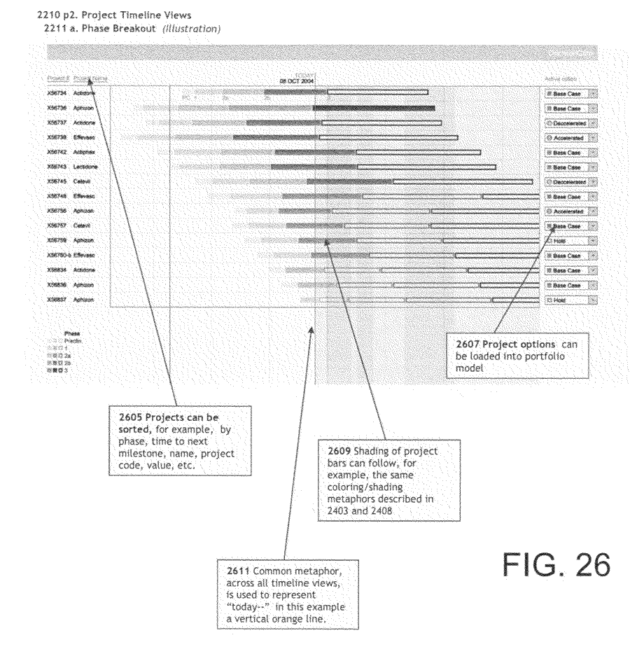

FIG. 26 illustrates a project timeline view by phase, an exemplary view assemblage from a DecisionCore solution application. As noted in 2609, a common BRM vocabulary (e.g., consistent shading to represent degrees of completion-BRM 1411—or a color scheme to indicate status relative to plan tolerances—BRM 1437) may be used consistently with views in FIGS. 24 and 25 where the same SOI or set of situations is being represented.

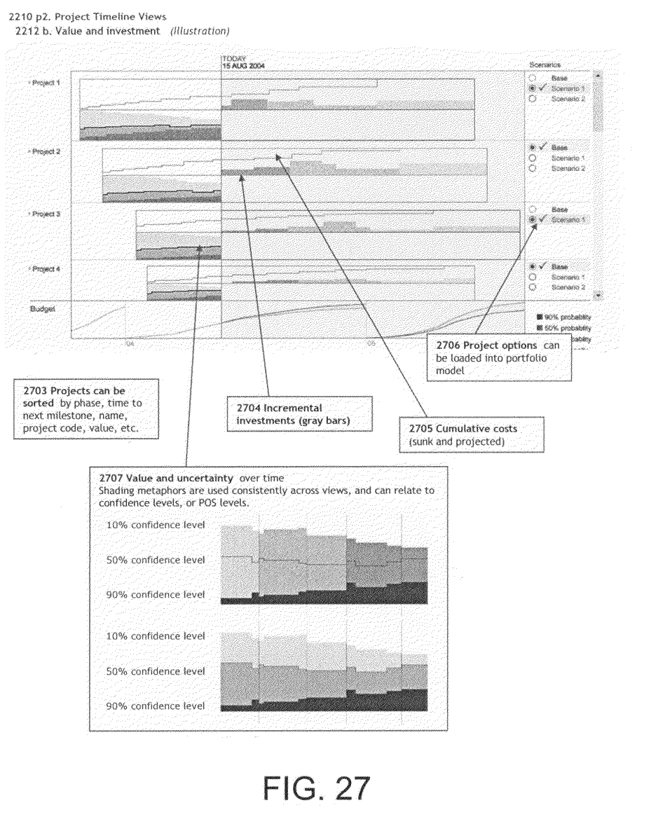

FIG. 27 illustrates a project timeline view by value/investment, an exemplary view assemblage from a DecisionCore solution application.

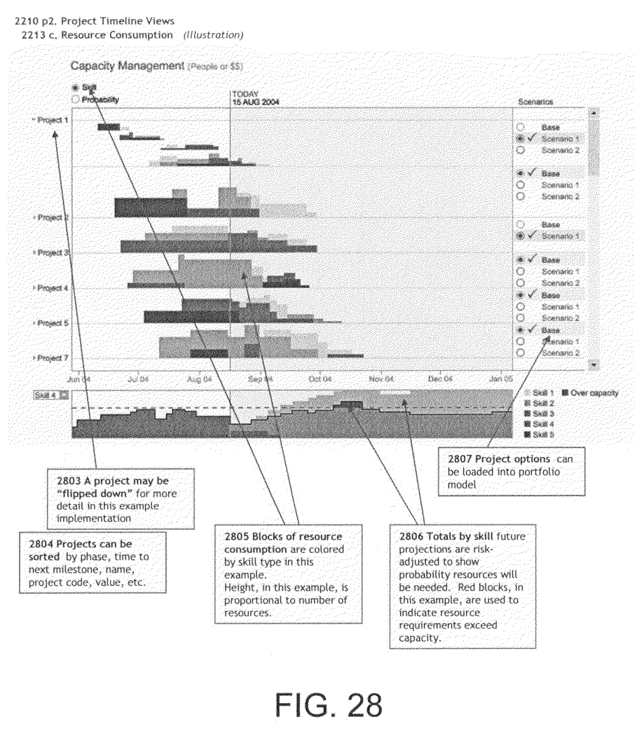

FIG. 28 illustrates a project timeline view by resource consumption (by skill type), an exemplary view assemblage from a DecisionCore solution application.

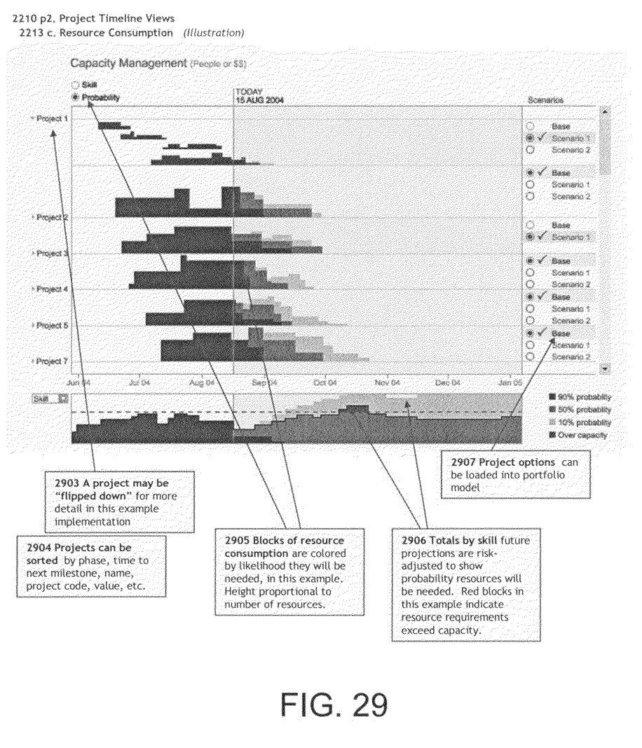

FIG. 29 illustrates a project timeline view by resource consumption (by probability), an exemplary view assemblage from a DecisionCore solution application. This and other risk-adjusted views in DecisionCore, and other application examples below (see Value Machine) use an extended vocabulary of BRM 1455: Uncertainty/probability.

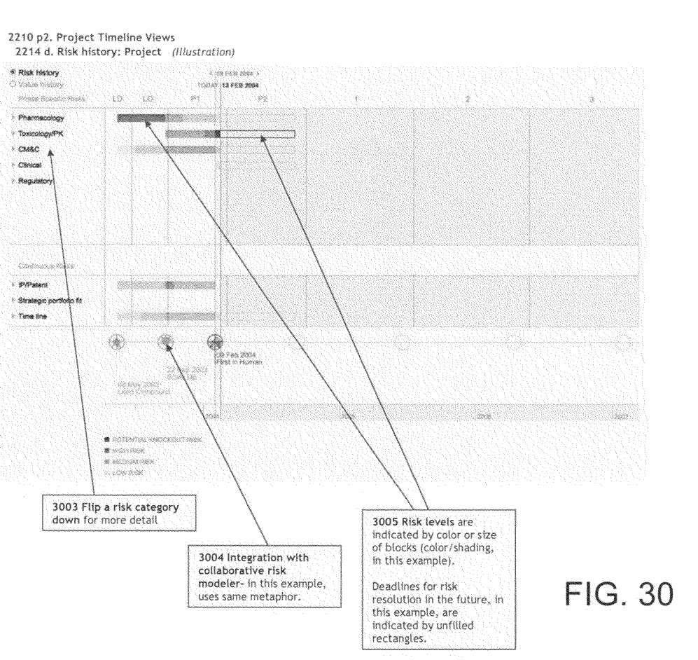

FIG. 30 illustrates a project timeline view by project risk history, an exemplary view assemblage from a DecisionCore solution application.

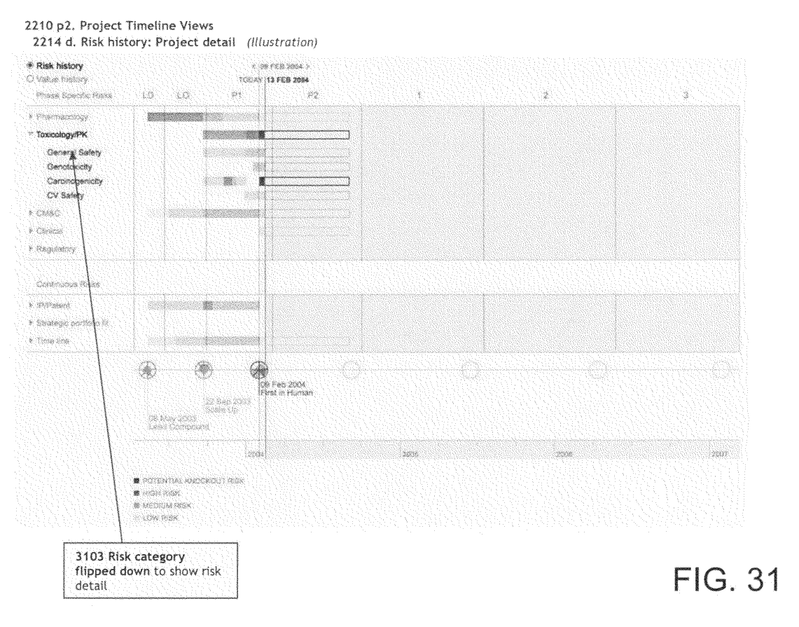

FIG. 31 illustrates a project timeline view by project risk history (detail), an exemplary view assemblage from a DecisionCore solution application.

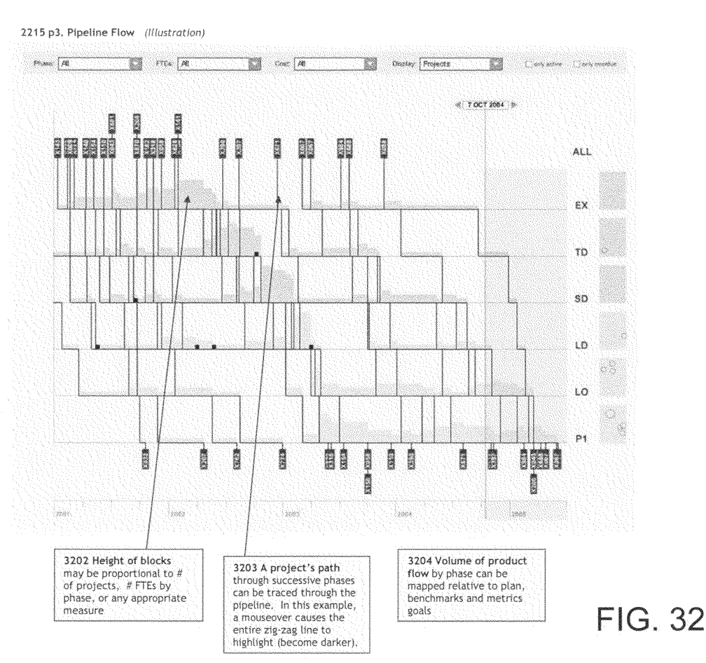

FIG. 32 illustrates a pipeline flow view, an exemplary view assemblage from a DecisionCore solution application. This view may also be risk-adjusted (BRM 1455: Uncertainty/probability) overlay.

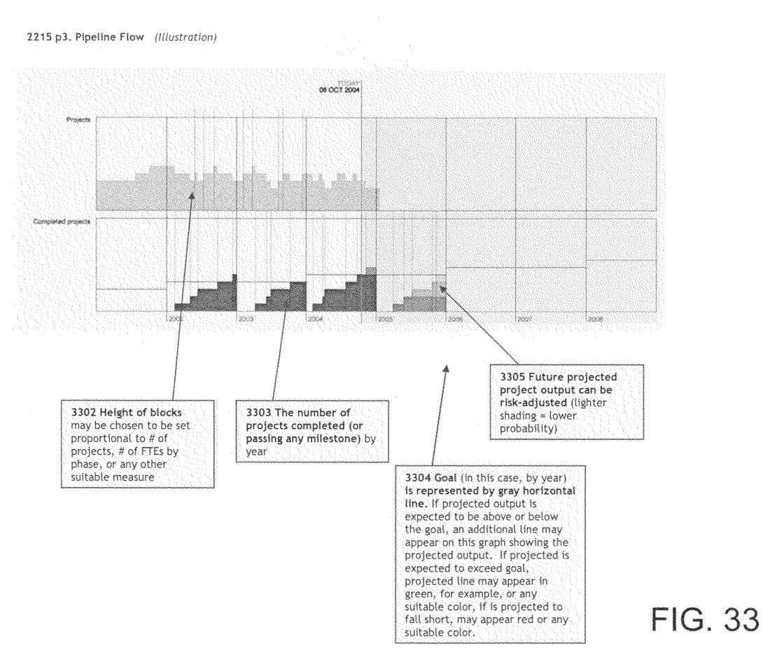

FIG. 33 illustrates part of a pipeline flow view, an exemplary view assemblage from a DecisionCore solution application.

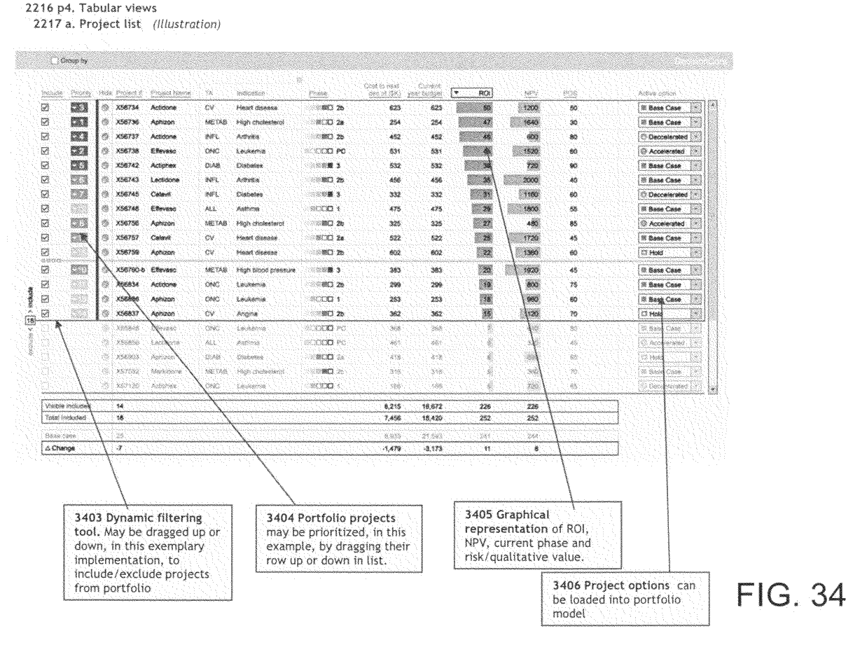

FIG. 34 illustrates a project list view, an exemplary view assemblage from a DecisionCore solution application.

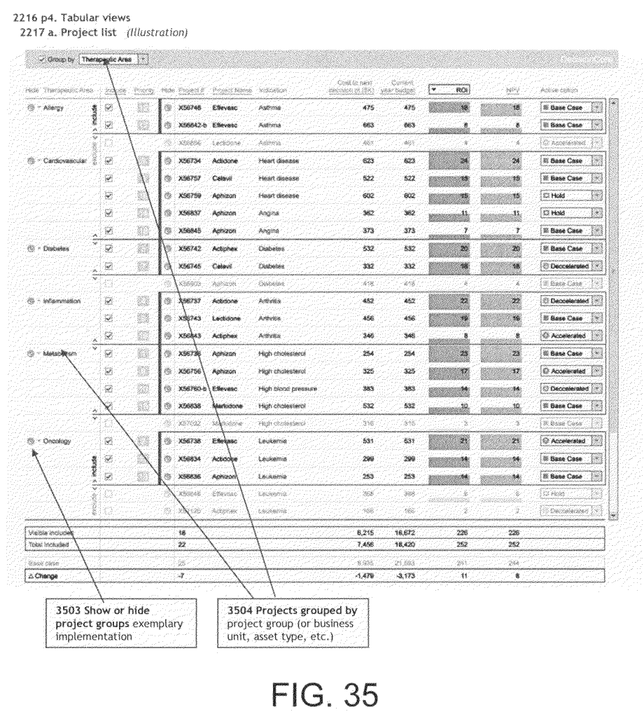

FIG. 35 illustrates a project list view, showing projects grouped by a project category, an exemplary view assemblage from a DecisionCore solution application.

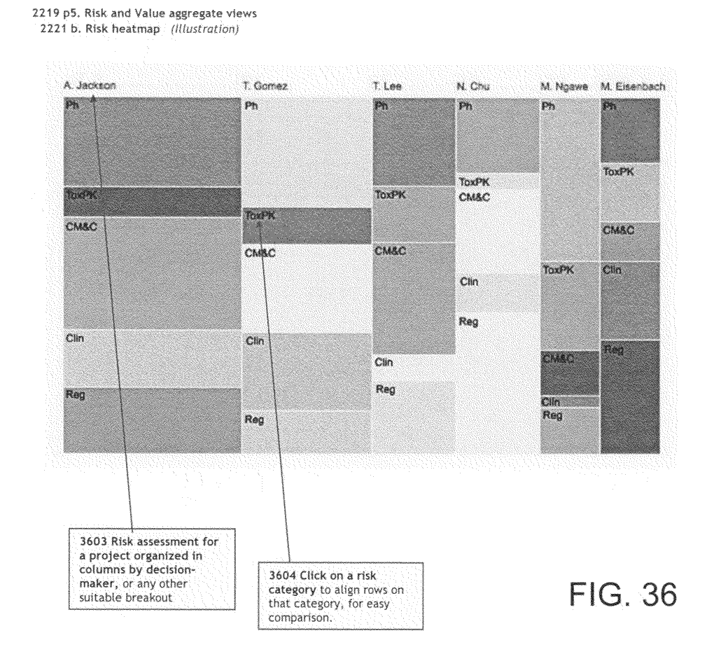

FIG. 36 illustrates a risk heatmap, an exemplary view assemblage from a DecisionCore solution application—exemplary AOM Matrix, BRM Comparison.

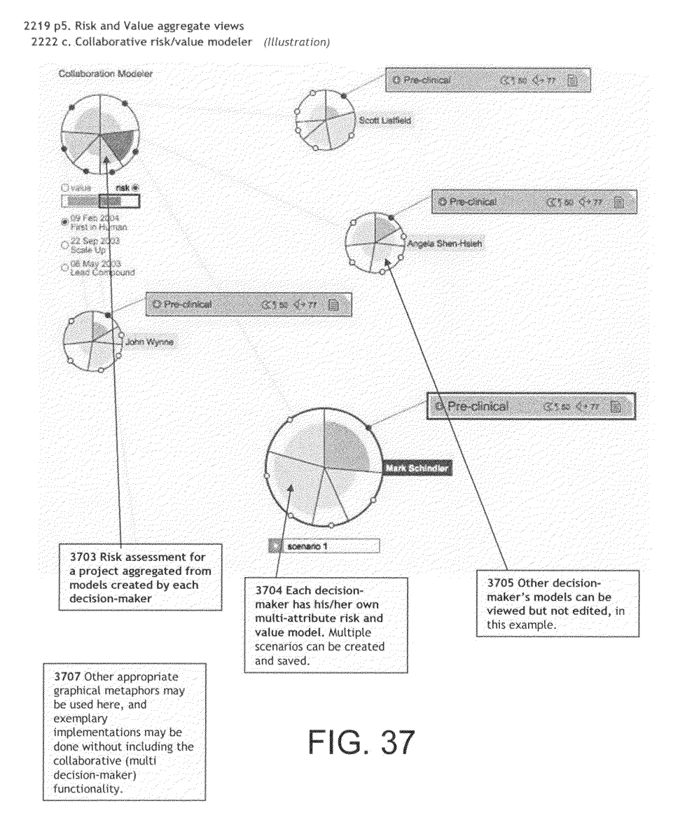

FIG. 37 illustrates a collaborative risk/value modeler, an exemplary view assemblage from a DecisionCore solution application.

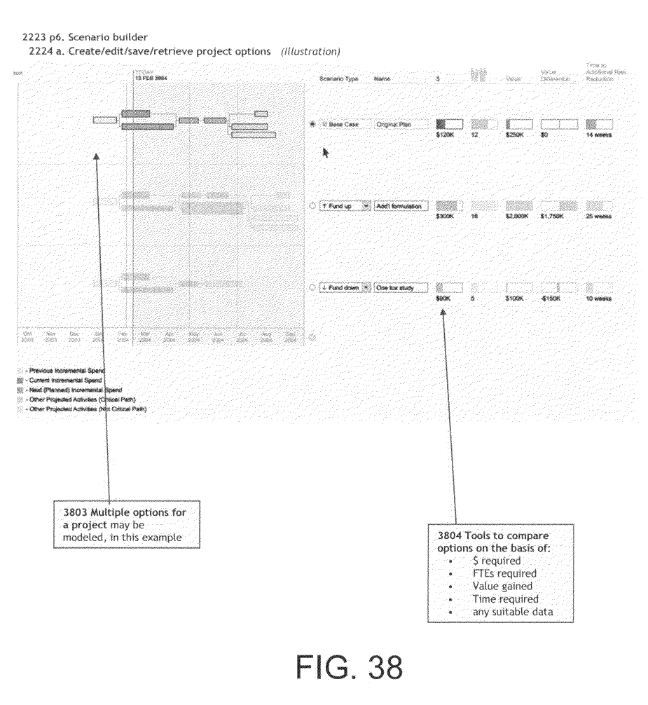

FIG. 38 illustrates an exemplary scenario builder, an exemplary view assemblage from a DecisionCore solution application.

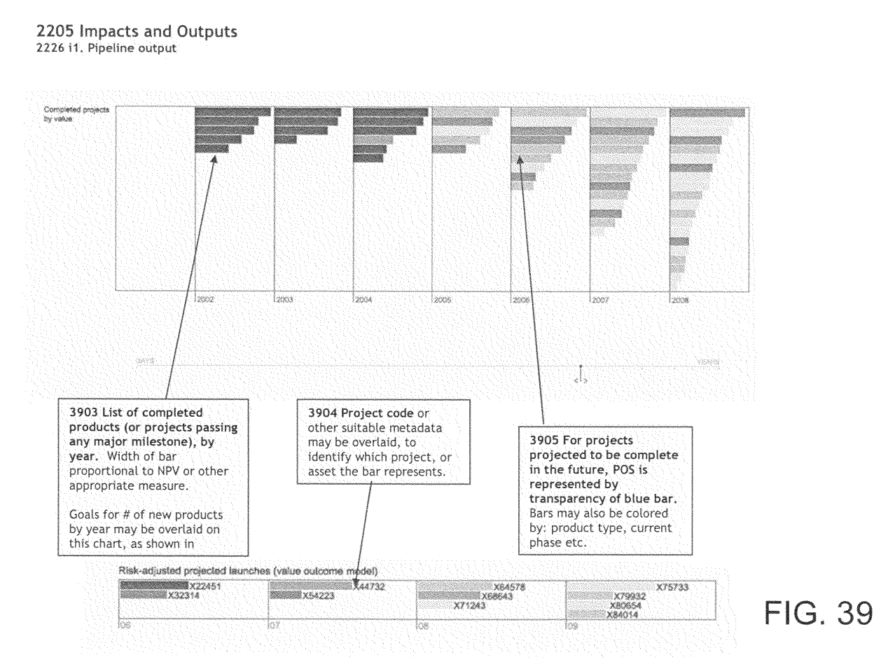

FIG. 39 illustrates a pipeline output assemblage, an exemplary view assemblage from a DecisionCore solution application.

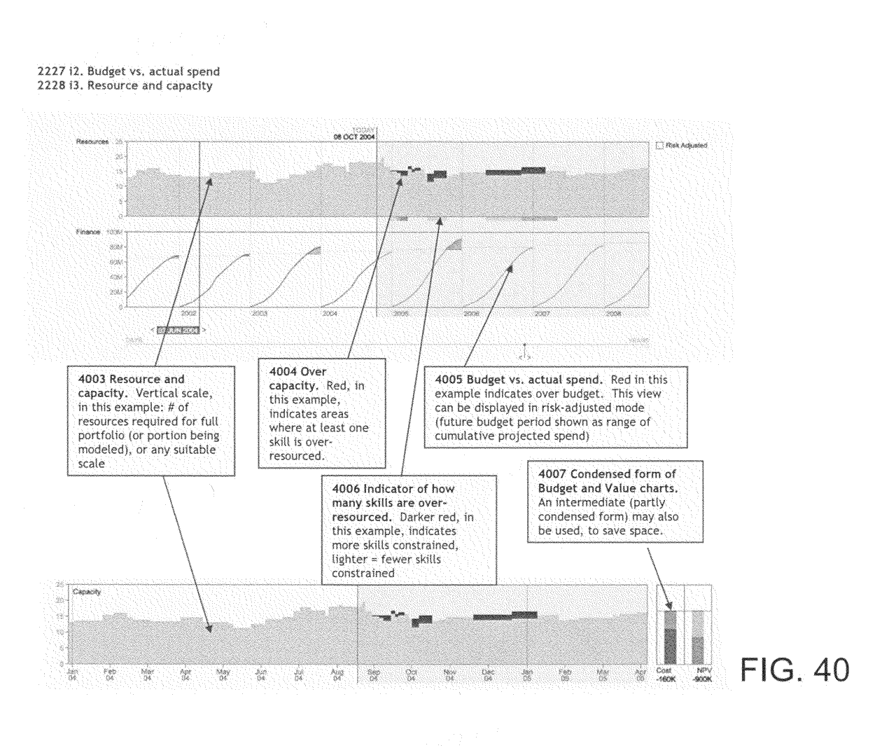

FIG. 40 illustrates exemplary budget vs. spend, and resource vs. capacity, exemplary view assemblages from a DecisionCore solution application.

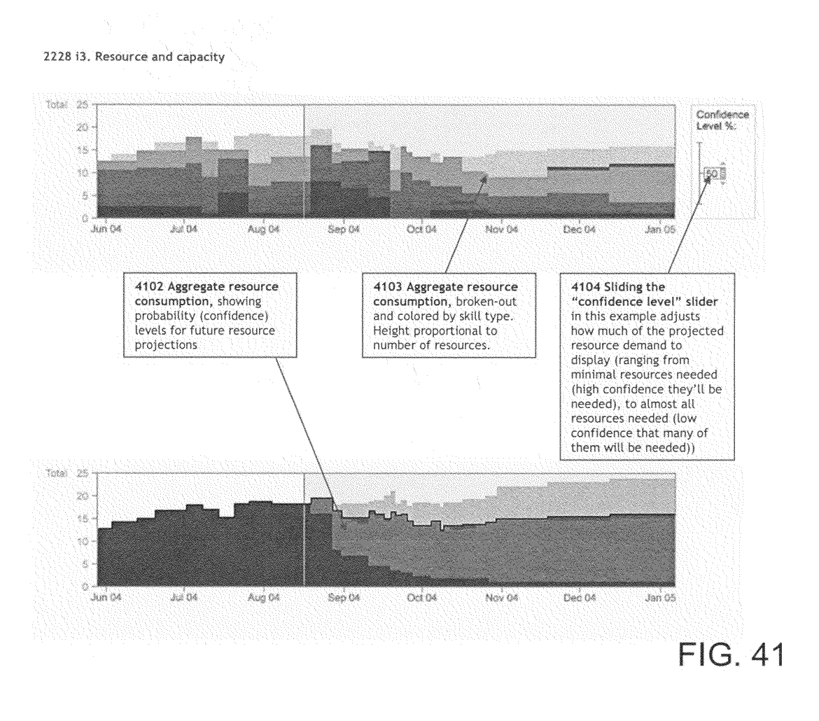

FIG. 41 illustrates exemplary resource vs. capacity view assemblages, showing the effect of a confidence level slider, exemplary assemblages from a DecisionCore solution application.

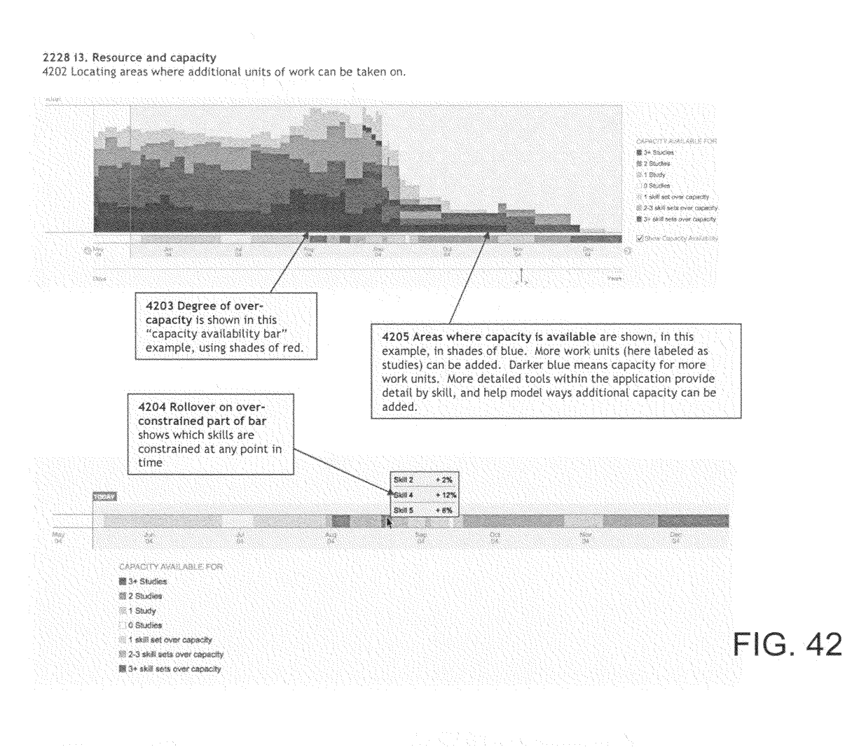

FIG. 42 illustrates exemplary capacity opportunity areas on a resource vs. capacity view, an exemplary view assemblage from a DecisionCore solution application.

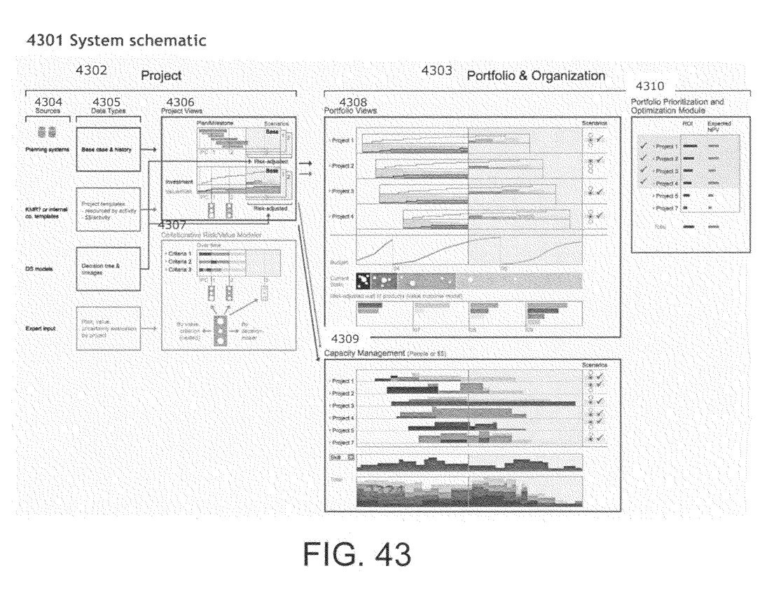

FIG. 43 illustrates an exemplary solution map (schematic) from an exemplary DecisionCore solution application.

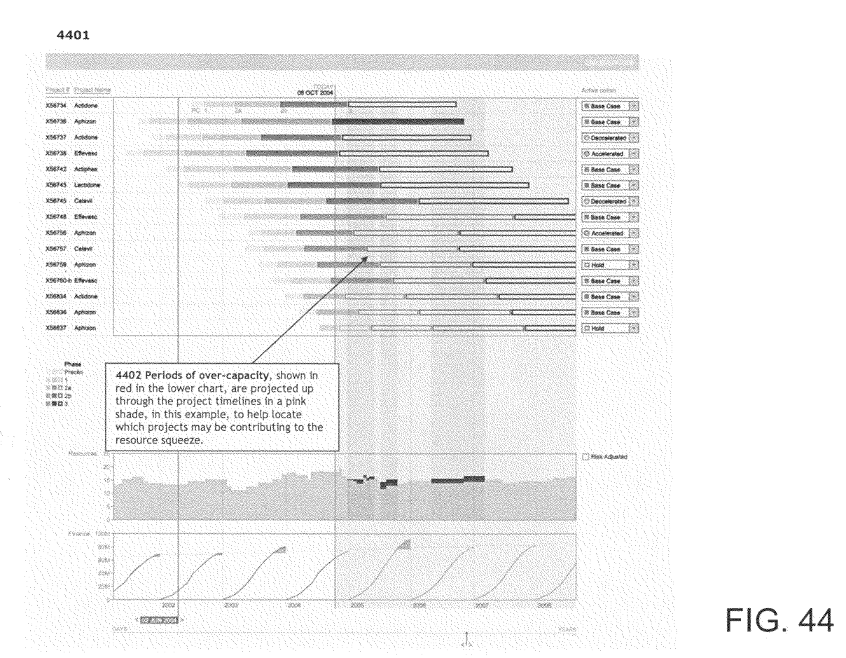

FIG. 44 illustrates an alternate embodiment of a project timeline view by phase, an exemplary view assemblage from a DecisionCore solution application.

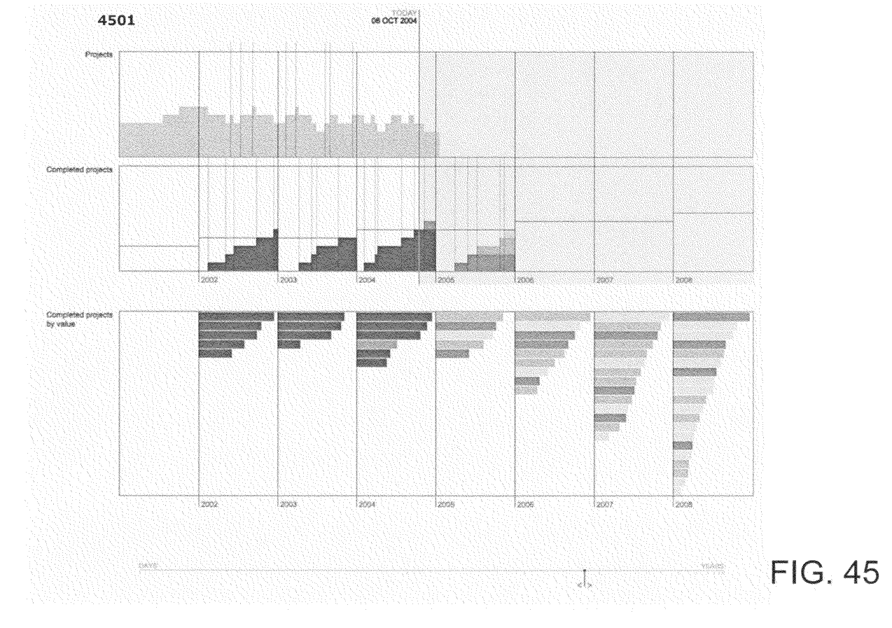

FIG. 45 illustrates an alternate embodiment of a pipeline flow, an exemplary view assemblage from a DecisionCore solution application.

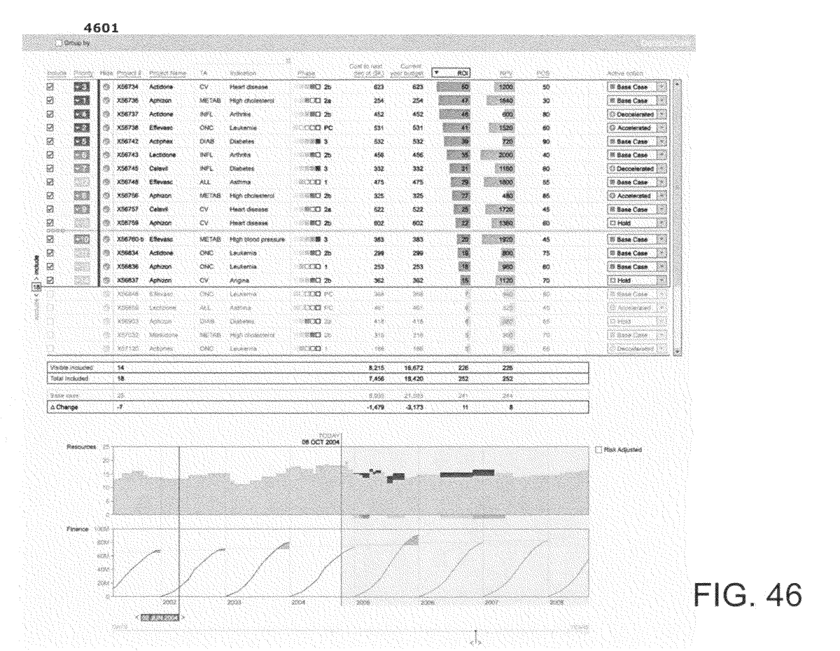

FIG. 46 illustrates an alternate embodiment of a project list view, an exemplary view assemblage from a DecisionCore solution application.

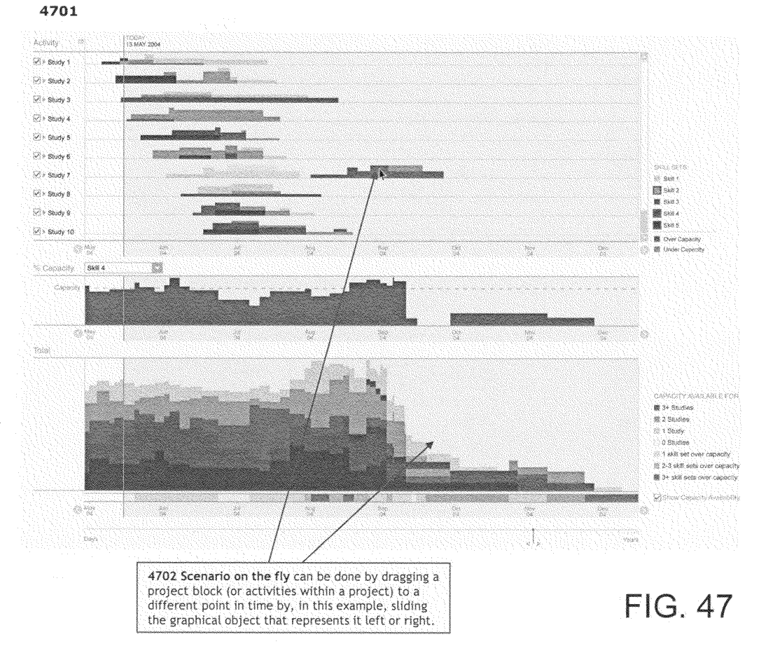

FIG. 47 illustrates an exemplary project timeline view by resource consumption, showing how dragging one of the project assemblages to a new date produces a recalculation of the resources and capacity.

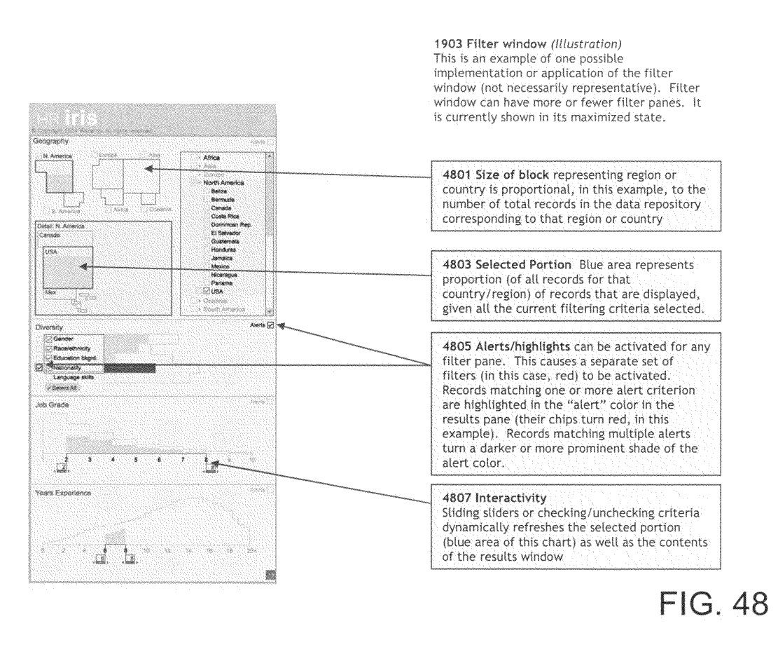

FIG. 48 illustrates an exemplary filter assemblage, as part of an exemplary Iris solution application.

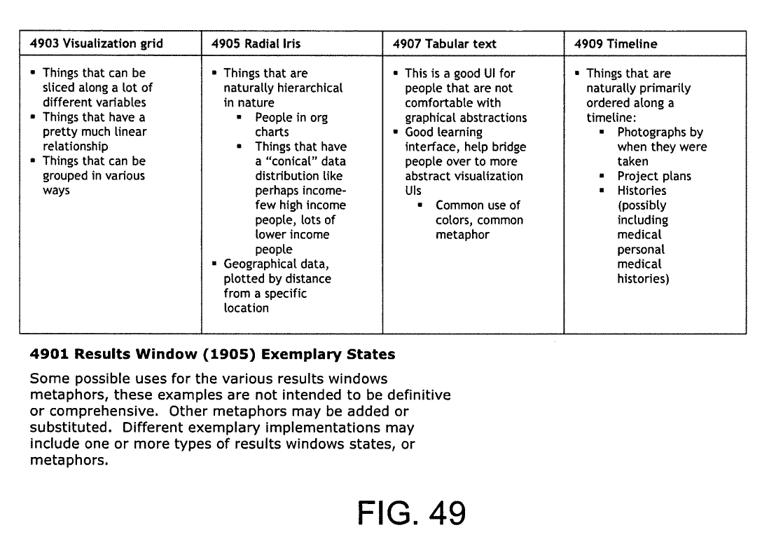

FIG. 49 illustrates alternate example states of an exemplary Iris results assemblage.

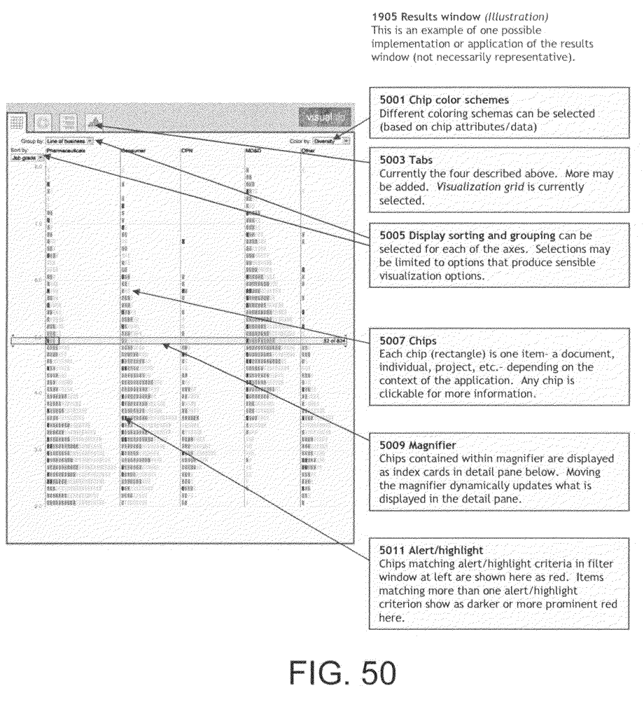

FIG. 50 illustrates exemplary elements of a results assemblage, as part of an exemplary Iris solution application.

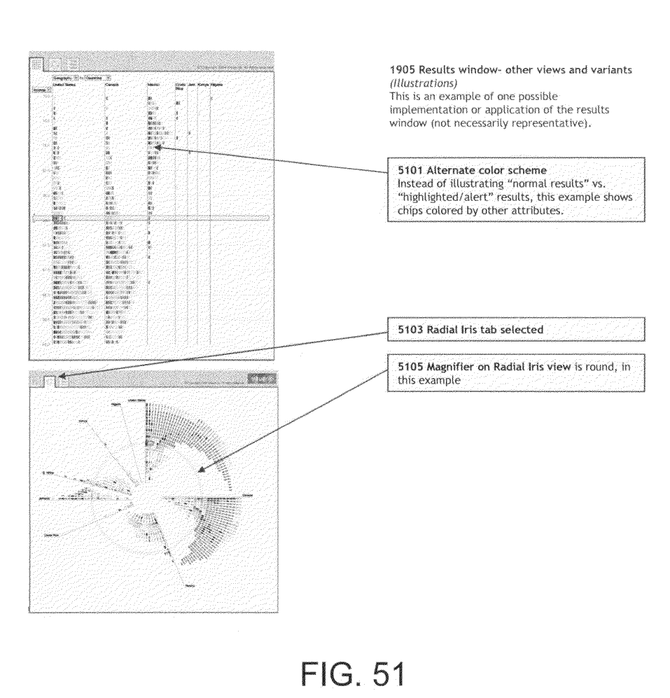

FIG. 51 illustrates other examples of results assemblages, as part of an exemplary Iris solution application.

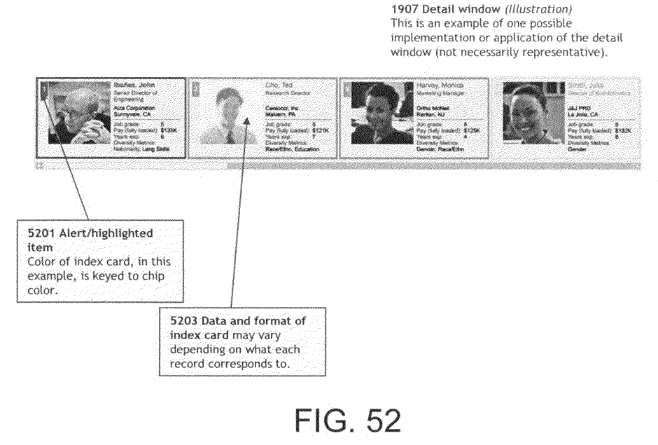

FIG. 52 illustrates exemplary features of a detail window assemblage, as part of an exemplary Iris solution application.

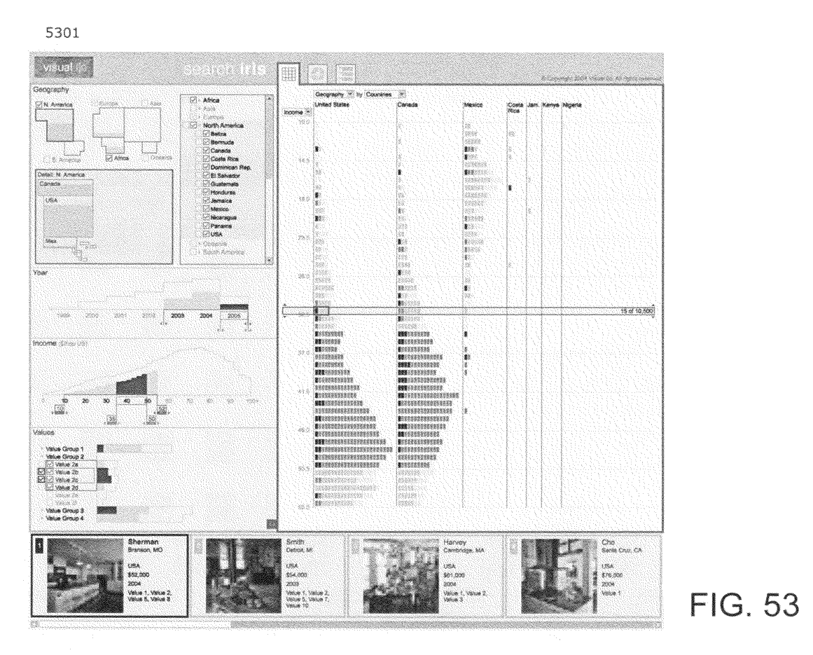

FIG. 53 illustrates an exemplary view from an Iris solution application, showing coloring/shading of results elements by priority.

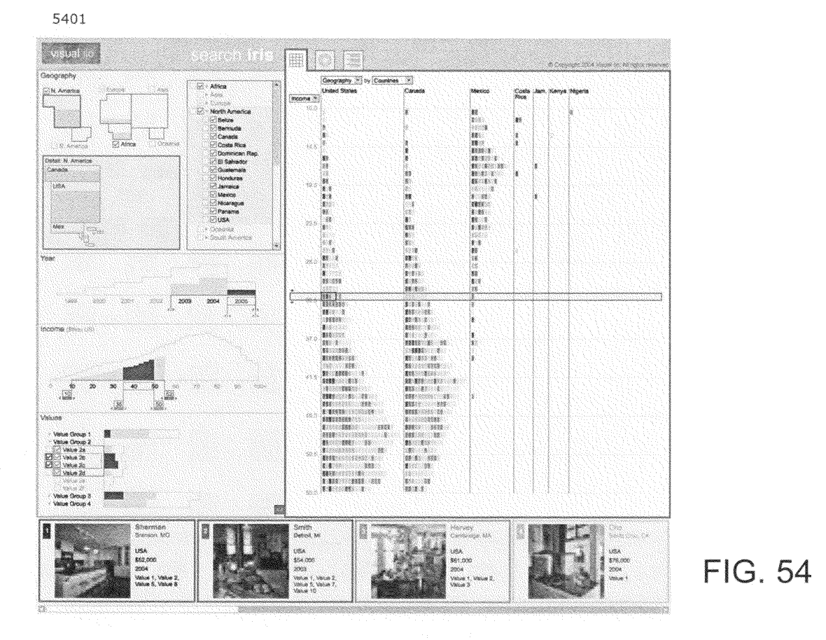

FIG. 54 illustrates an exemplary view from an Iris solution application, showing coloring/shading of results elements by category or other attributes.

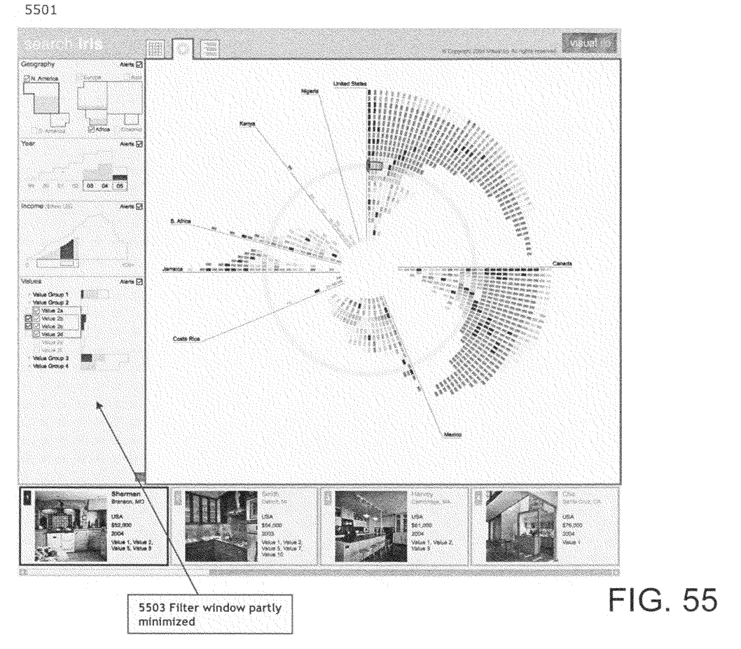

FIG. 55 illustrates an exemplary view from an Iris solution application, showing a radial iris type results assemblage, and coloring/shading of results elements by priority.

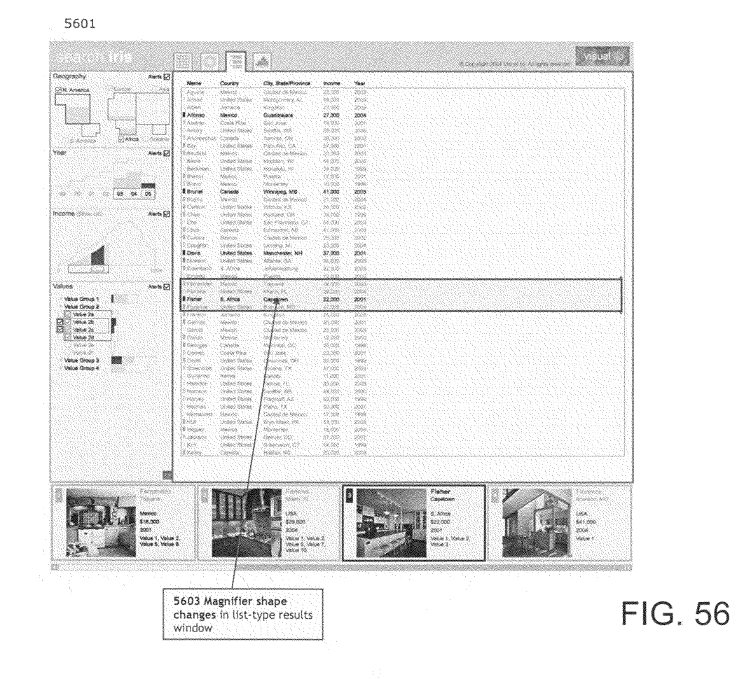

FIG. 56 illustrates an exemplary view from an Iris solution application, showing a list type results assemblage, and coloring/shading of results elements by priority.

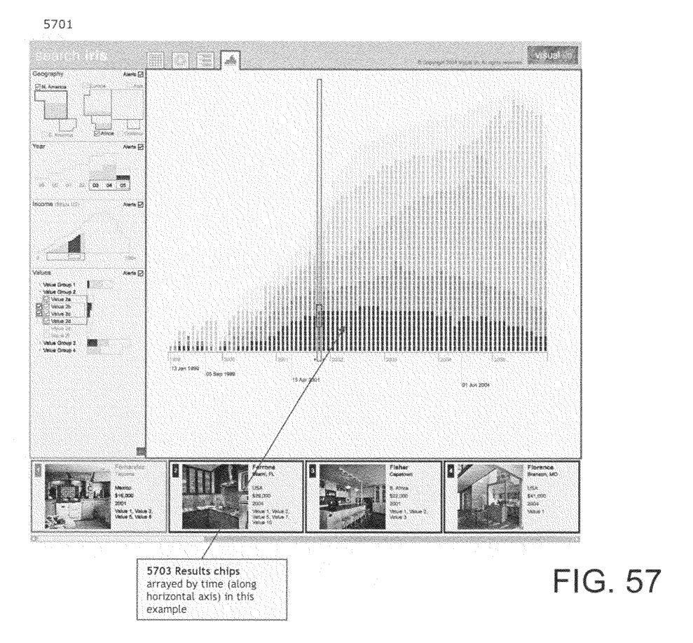

FIG. 57 illustrates an exemplary view from an Iris solution application, showing a timeflow-type results assemblage, and coloring/shading of results elements by priority.

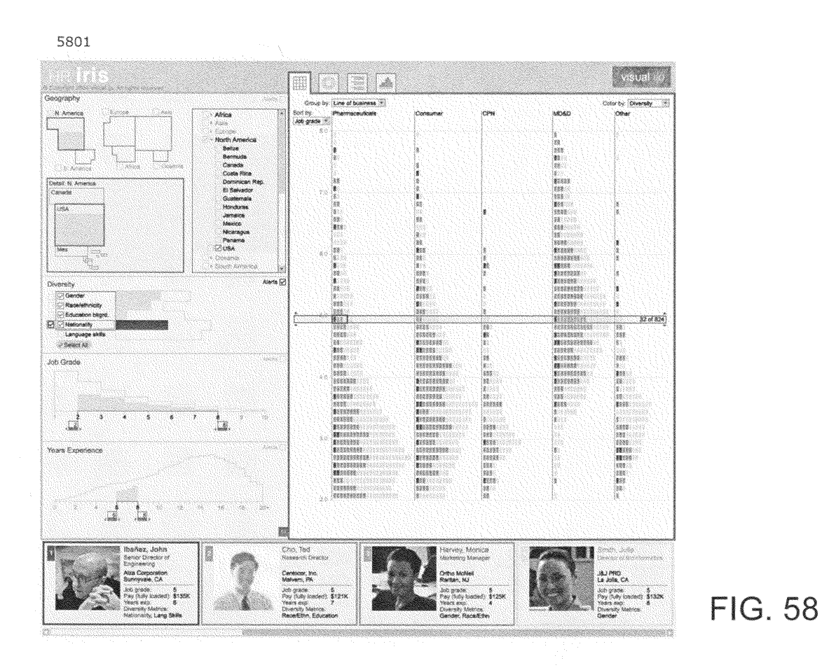

FIG. 58 illustrates an exemplary view from an Iris solution application, showing coloring/shading of results elements by intensity of match with a single filter type (e.g., Diversity, in this example).

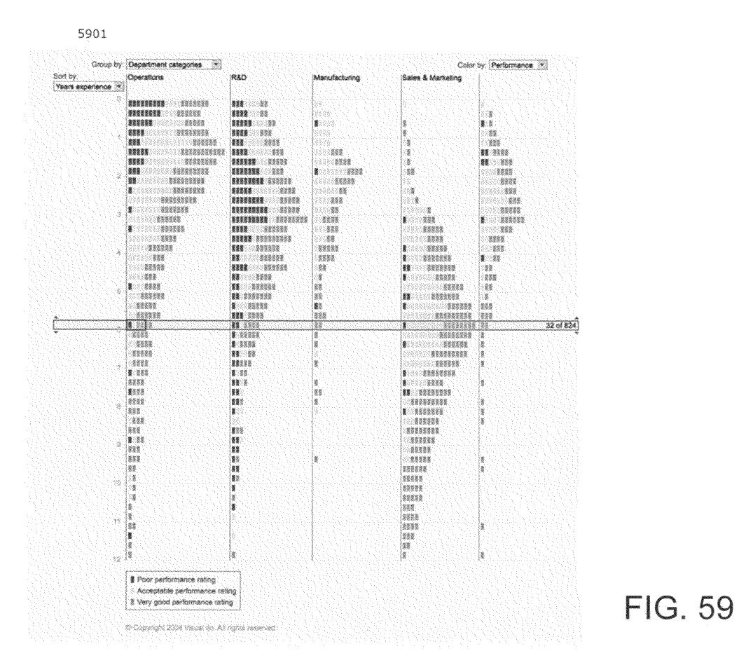

FIG. 59 illustrates an exemplary Iris results assemblage, showing coloring/shading of results by a variable value (e.g., performance, in this example).

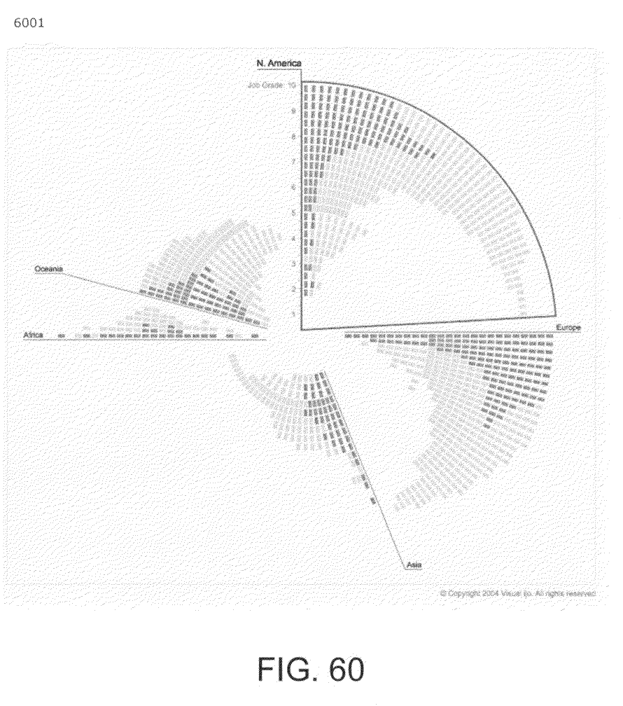

FIG. 60 illustrates an exemplary Iris results assemblage, in radial Iris format.

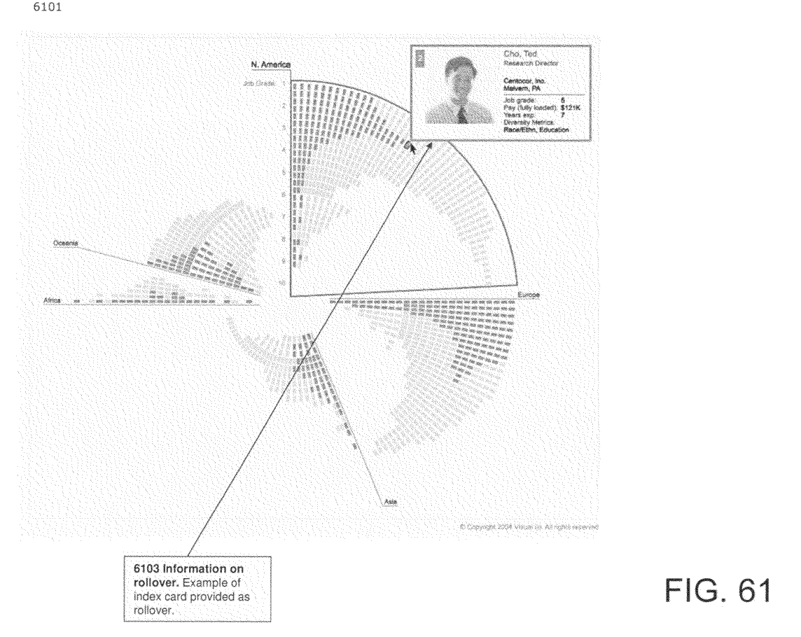

FIG. 61 illustrates an exemplary Iris results assemblage in radial Iris format, showing an exemplary detail mouseover for a result element.

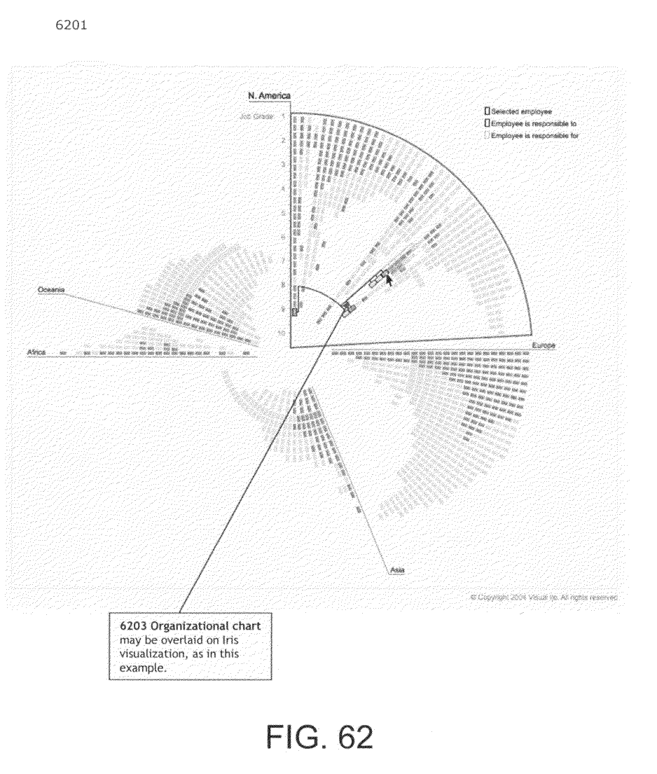

FIG. 62 illustrates an exemplary Iris results assemblage in radial Iris format, showing an exemplary overlay to represent hierarchical relationships among the results elements.

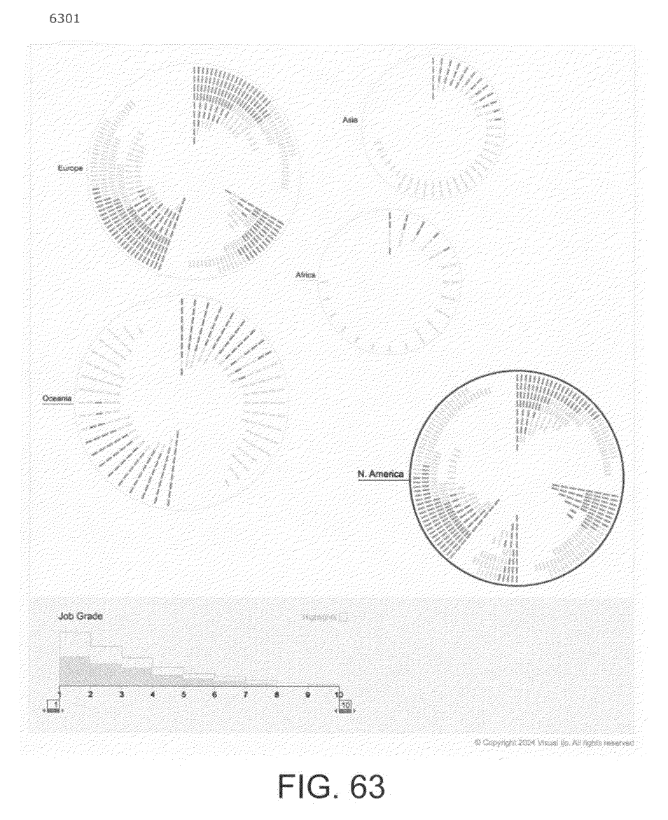

FIG. 63 illustrates an exemplary Iris results assemblage in radial Iris format, showing a single radial assemblage disassembled into multiple assemblages, each one representing a sub-category of the original assemblage (in this case each radial assemblage representing one region within the world).

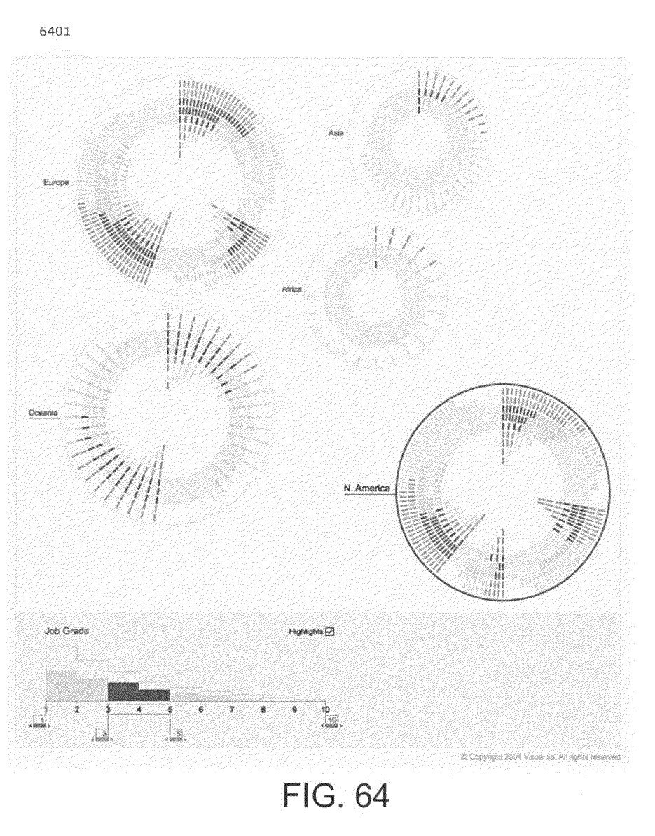

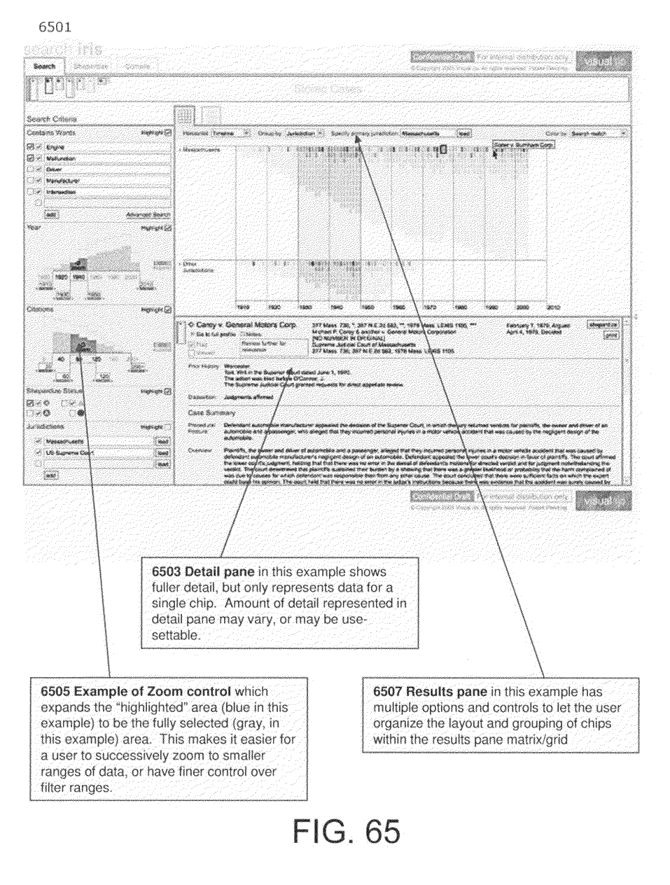

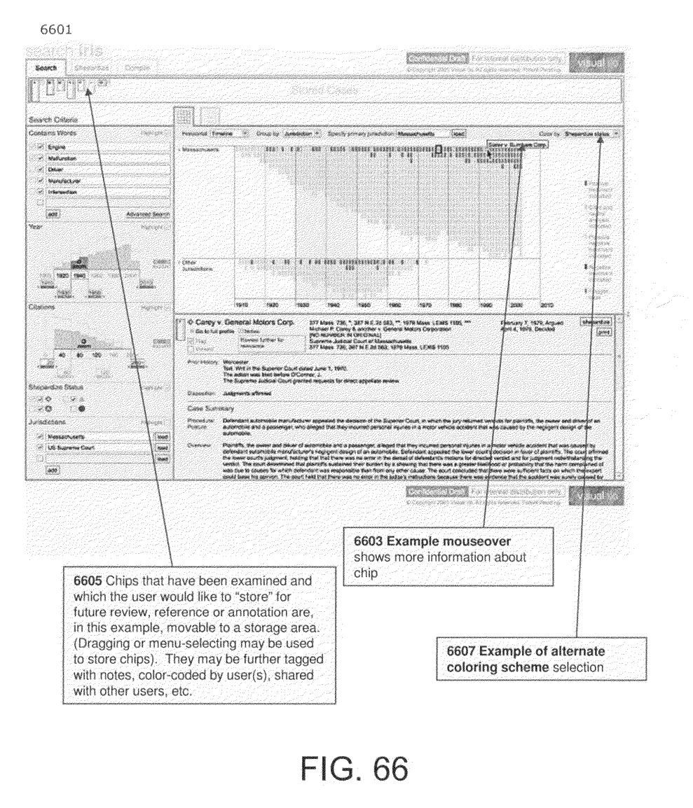

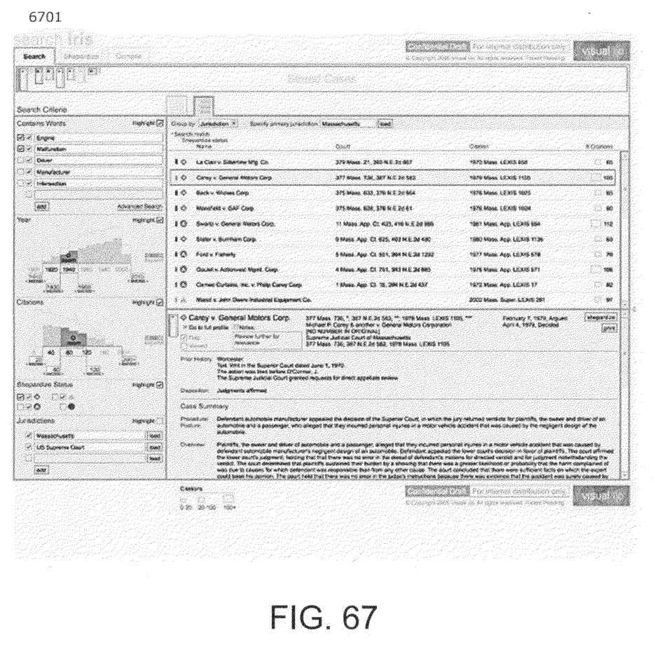

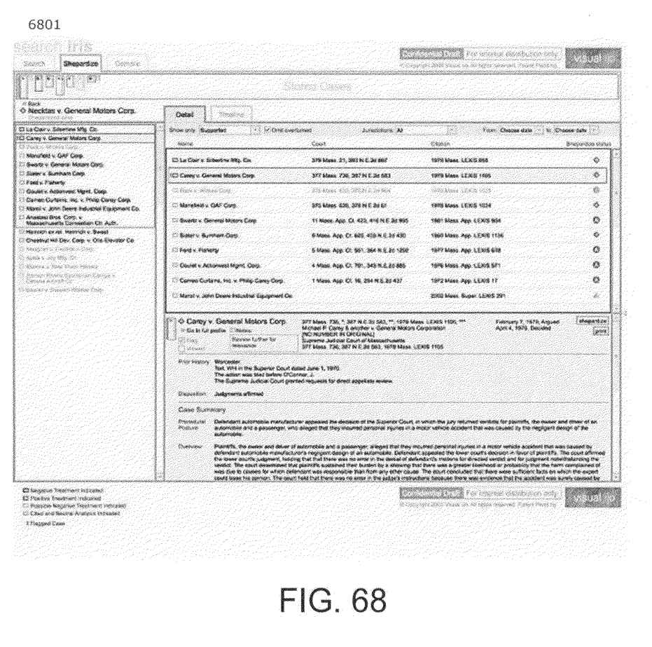

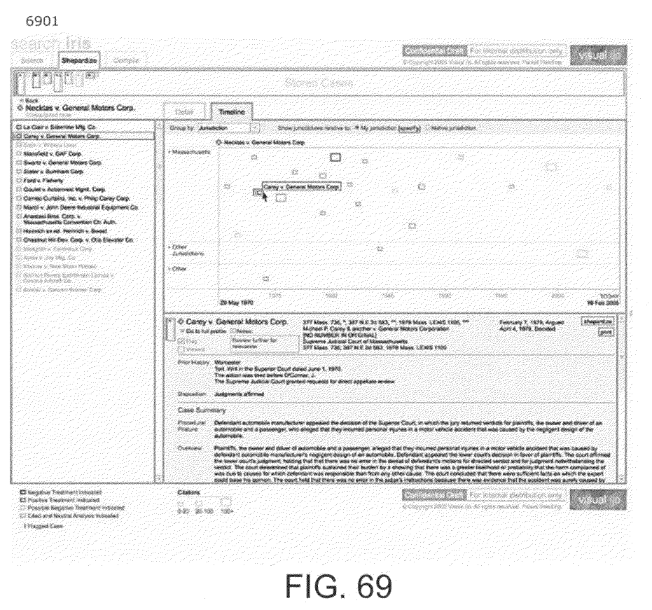

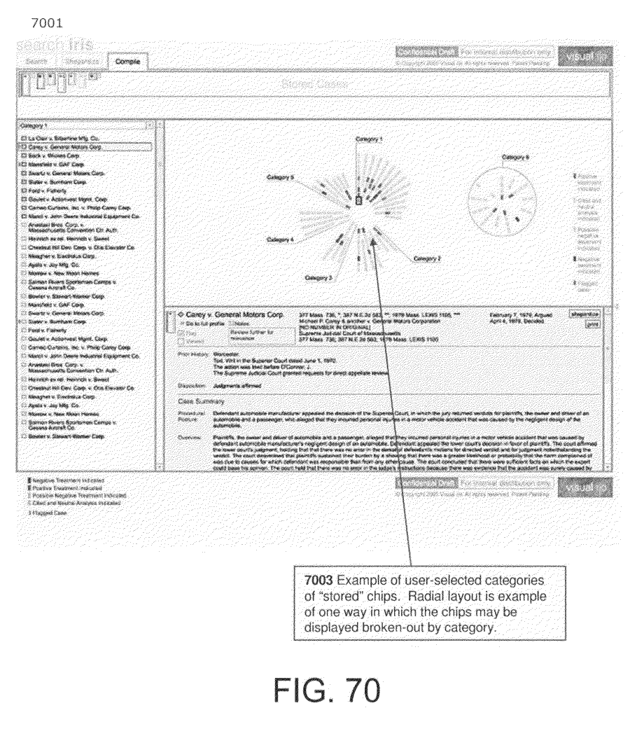

FIG. 64 illustrates the same exemplary assemblage as in FIG. 63, except with a range of criteria highlighted.

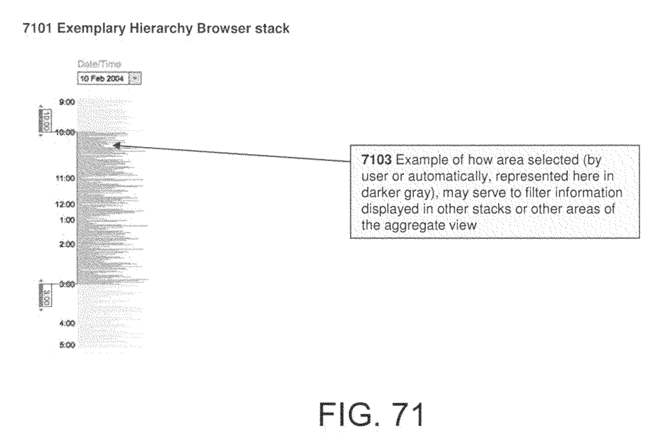

FIG. 71 illustrates an exemplary Hierarchy Browser stack, in one sample state. A stack is comprised of one or more graphical elements, arranged in a row or column. Each graphical element (in this example, a horizontal line) represents some information or data (for example, a record in a database), and the entire stack represents the collection of all of the individual elements comprising it. Any appropriate dimension of a stack element (or of the entire stack or one of its segments) may be proportional to any suitable data element associated with the stack element or stack segment. For example, in FIG. 71, the horizontal length of each of the stack element lines is proportional to price, a data field associated each of the elements. Stack(s) may be operated upon by the user in a variety of ways—by, for example, changing its display or behavior modes, selecting a portion (or range) of elements within a stack (as in 7103), highlighting a portion or range of elements, etc. A stack may be dragged to another location within a view (which may, for example, change its position within a cascading set of filters or queries). A stack may be populated by different datasets. The scale, size, color shading, etc. of the elements within a stack may change based on actions such as selecting, filtering etc. different stack elements. For example, the vertical dimension of each element within a stack may change automatically depending on how many elements are currently displayed within that stack.

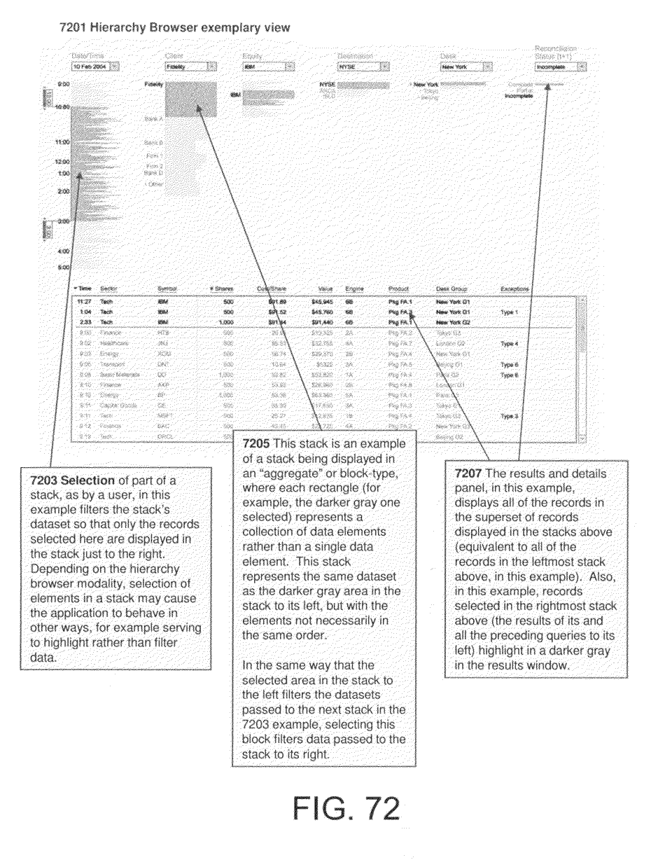

FIG. 72 illustrates an exemplary view from a Hierarchy Browser solution application.

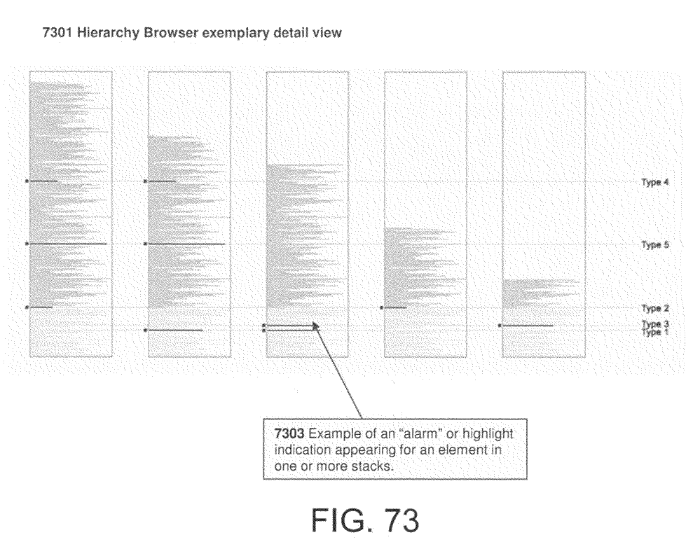

FIG. 73 illustrates an exemplary view of a Hierarchy Browser solution application, with each stack representing the same dataset filtered in different ways.

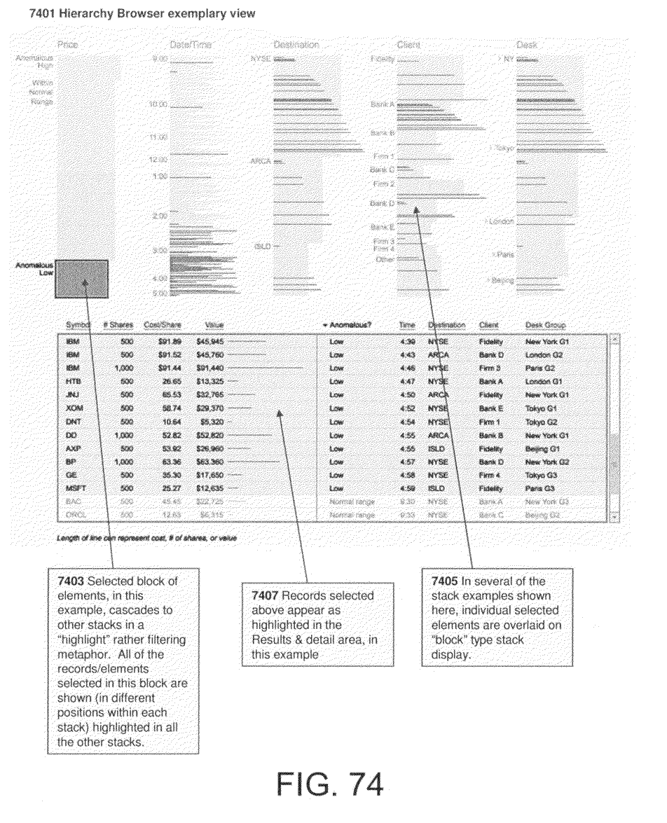

FIG. 74 illustrates an exemplary view of a Hierarchy Browser solution application, in a mode whereby user selection of a stack segment causes highlighting, rather than filtering of datasets as they are passed to subsequent stacks.

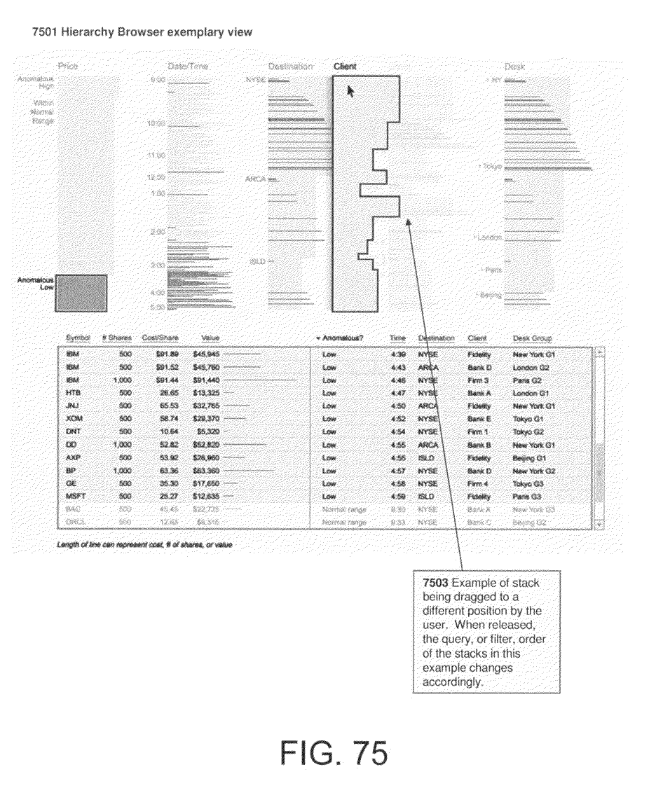

FIG. 75 illustrates an exemplary view of a Hierarchy Browser solution application, showing an example of how a stack may be dragged by a user to a new location within the stack order.

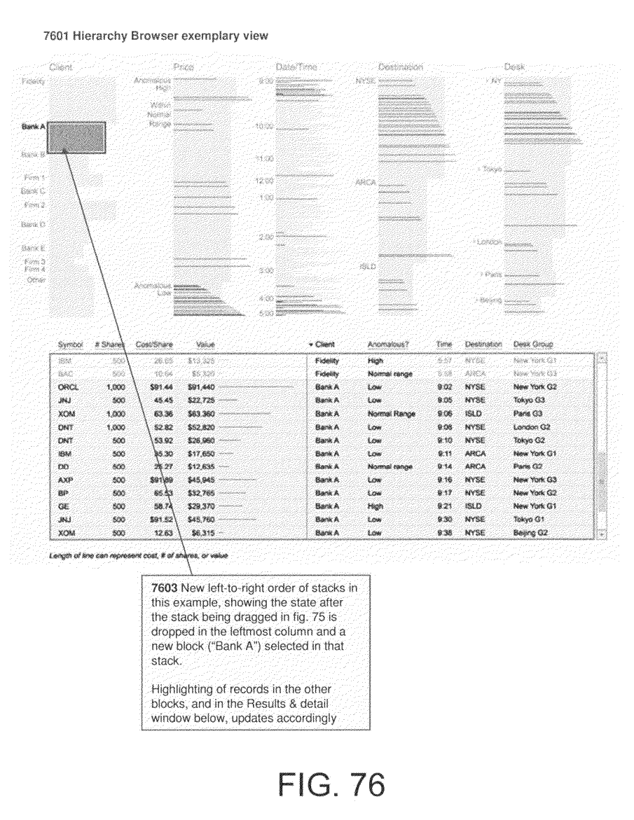

FIG. 76 illustrates an exemplary view of a Hierarchy Browser solution application, showing an example result of the dragging operation illustrated in FIG. 75.

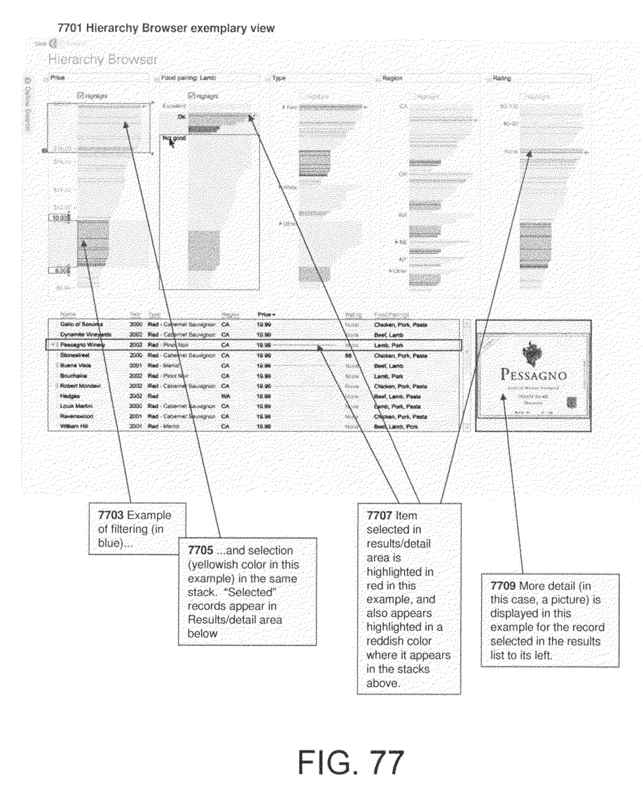

FIG. 77 illustrates an exemplary view of a Hierarchy Browser solution application, showing examples of various selection and highlighting actions.

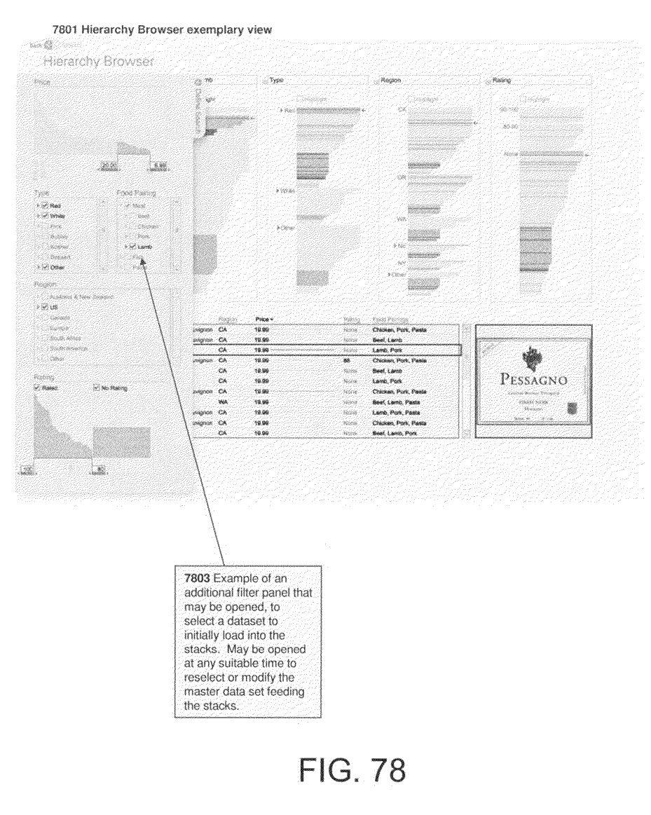

FIG. 78 illustrates an exemplary view of a Hierarchy Browser solution application, showing an example use of a filter window to determine the initial dataset loaded into the stacks.

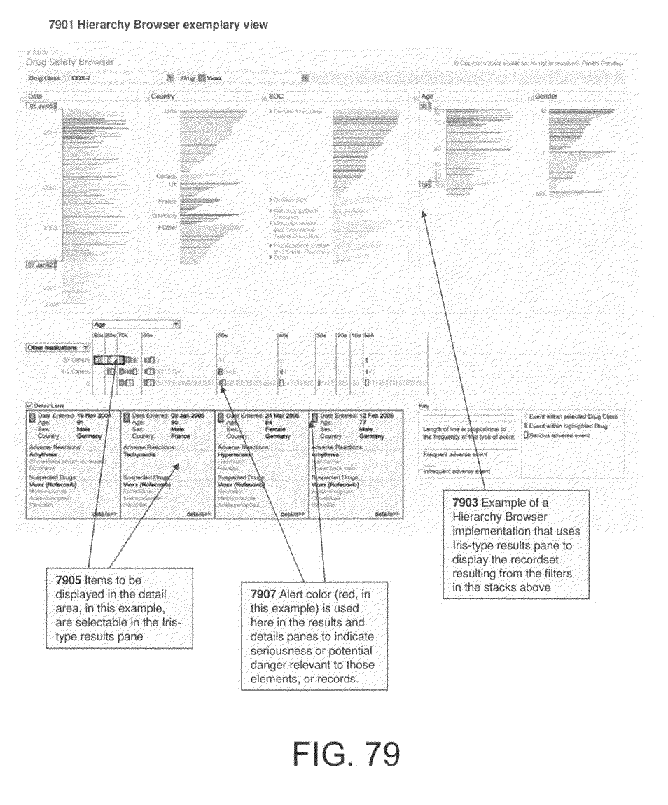

FIG. 79 illustrates an exemplary view of a Hierarchy Browser solution application, showing examples of filtering and highlighting in the stacks area, and an example of multiple levels of detail within the Results & detail area.

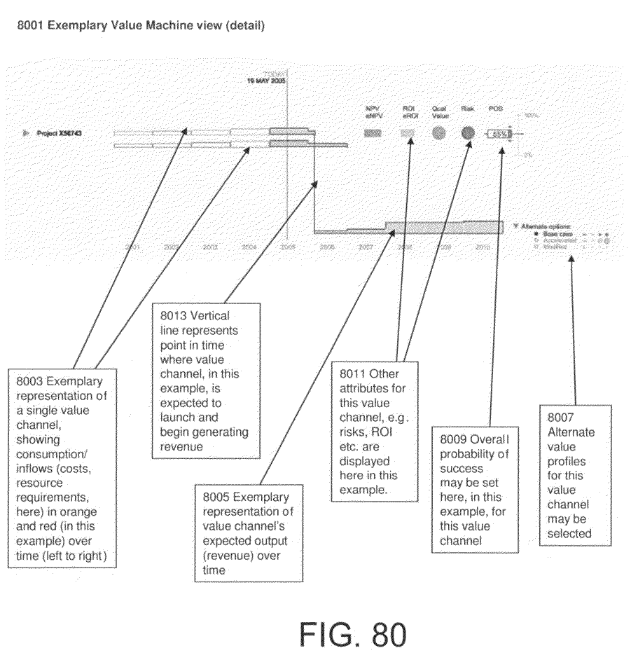

FIG. 80 illustrates an exemplary assemblage from a Value Machine solution application, showing the elements of a value channel.

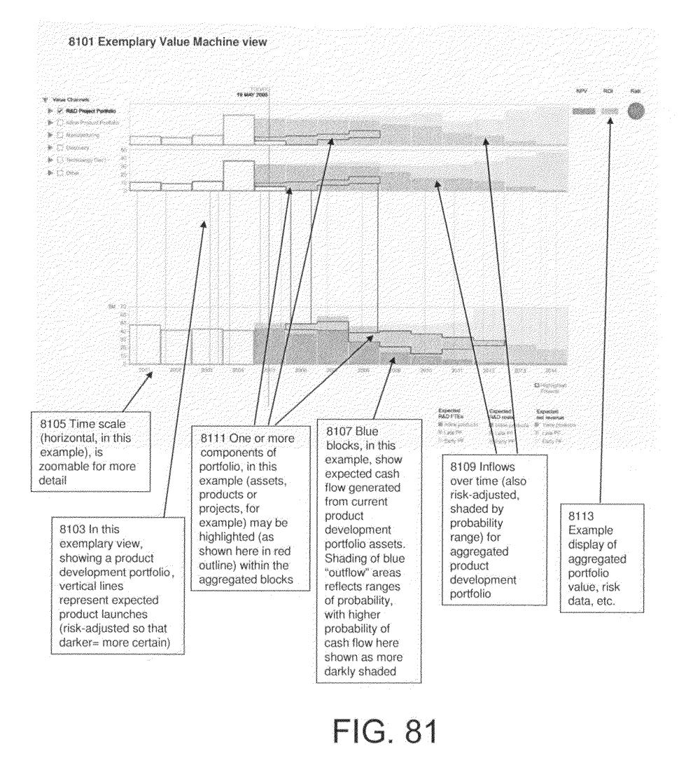

FIG. 81 illustrates an exemplary view of a Value Machine solution application, showing value channels rolled-up into aggregate inflows (above) and aggregate outflows (below).

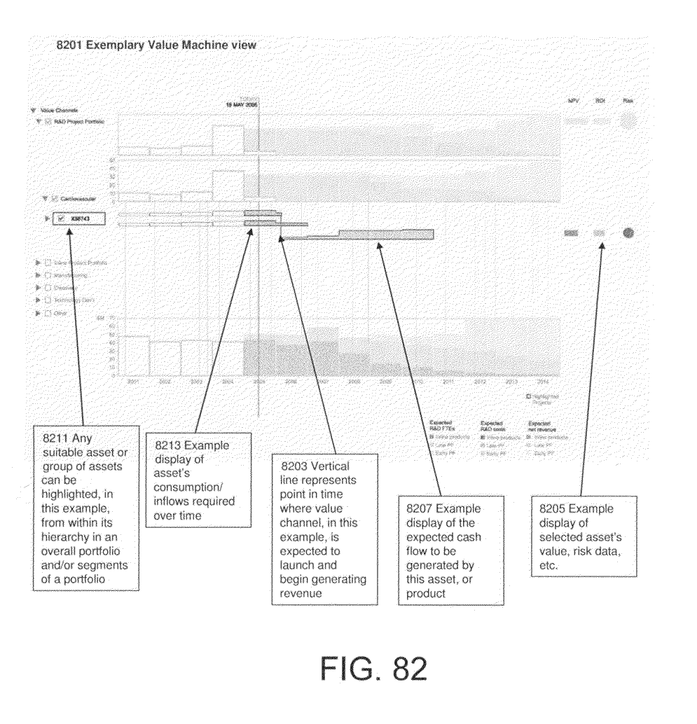

FIG. 82 illustrates an exemplary view of a Value Machine solution application, showing an example of a workspace area opened to display a value channel (in the middle of the screen) in context of the aggregated channels (above and below).

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

### LIST OF REFERENCES

[1] Jock Mackinlay, “Automating the Design of Graphical Presentations of Relational Information,” ACM Transactions on Graphics, Vol. 5, No. 2, April 1986, Pages 110-141.
[2] Roth, S. and Mattis, J., 1990, Data characteristization for intelligent graphics presentation. In Proceedings CHI '90, April, pp. 193-200. ACM Press.
[3] Stephen M. Casner, A Task-Analytic Approach to the Automated Design of Graphic Presentations, ACM Trans Graphics, Vol. 10, No. 2, April 1991, Pages 111-151.
[4] S. Wehrend and C. Lewis, A problem-oriented classification of visualization techniques. In Proceedings IEEE Visualization '90, pp. 139-143.
[5] R. L. Harris, Information Graphics, Oxford University Press, New York City, USA, 1999.
[6] J. E. Russo et al, Decision Traps, Simon & Schuster, New York City, USA, 1990.
[7] G. Klein, Sources of Power, The MIT Press, Cambridge, USA, 1999.
[8] T. G. West, In The Mind's Eye, Prometheus Books, Amherst, USA, 1997.
[9] S. T. Card et al, Readings in Information Visualization, Academic Press, San Diego, USA, 1999.
[10] N. Macdonald et al, “Panel: Beyond Human-Centered Design?”, Proceedings of DIS2004, Cambridge, USA, pp. 373-374, 2004.
[11] S. Few, Show Me the Numbers, Analytics Press, Oakland, USA, 2004.
[12] E. R. Tufte, The Visual Display of Quantitative Information, Graphics Press, Cheshire, USA, 1995.

What is claimed is:

1. A method for creating a software application specification, the method comprising:
arranging graphical elements to form assemblages comprising one or more information displays of the graphical elements;
classifying each of the assemblages from the arranging step along at least two dimensions, including a layout type dimension, and a relationship metaphor dimension;
specifying each of the assemblages from the arranging step by attributes of a situation being studied;
associating each of the assemblages from the arranging step, respectively, so as to describe a behavior of the graphical elements included within each of the respective assemblages; and
generating a software application specification based on a combination of the assemblages.

2. The method of claim 1, further comprising generating a software application based on the software application specification, wherein the software application includes an information system user interface for graphically displaying data related to the combination of the assemblages.

3. The method of claim 1, wherein the associating step includes encoding or linking each of the assemblages from the assembling step, respectively, so as to describe the behavior of the graphical elements included within each of the respective assemblages.

4. The method of claim 1, wherein the behavior includes at least one of positioning, movement, coloring, shading, and size.

5. The method of claim 1, wherein the arranging step includes arranging the graphical elements into a plurality of layouts, formats, configurations, and orientations.

6. The method of claim 1, wherein the graphical elements include at least one of rectangles, circles, ellipses, lines, raster images, curves, freeform shapes, symbols, text, labels, blocks of text, and icons.

7. The method of claim 1, wherein the arranging step includes applying a set of design variables to one or more of the graphical elements.

8. The method of claim 7, wherein the design variables include at least one of color of the graphical elements, shading of the graphical elements, transparency of the graphical elements, contrast of the graphical elements, brightness of the graphical elements, bordering line weight of the graphical elements, line color of the graphical elements, size of the graphical elements, dimensions of the graphical elements, and rotation of the graphical elements.

9. The method of claim 1, wherein the arranging step includes arranging the graphical elements in a display layout based on a set of combination metaphors.

10. The method of claim 1, further comprising mapping a real world decision or problem-solving process to a standard decision model.

11. The method of claim 10, wherein the mapping step includes one or more high level steps, including a monitoring step, an experience or triggering step, an assessing step, a modeling step, an evaluating step, a deciding step, and an implementing step.

12. The method of claim 11, wherein one or more of the high level steps include one or more detailed decision steps linked to one or more relationship metaphors of the relationship metaphor dimension.

13. The method of claim 11, further comprising describing the attributes of the situation being studied based on a framework, including at least one of situation perspectives, situation details or context, situation datastreams, and situation time structures.

14. The method of claim 13, further comprising:
employing a decision mapping step, including,
correlating steps of a decision or problem-solving process with the decision or problem-solving process of the standard decision model,
linking one or more of the correlated steps with one or more of the relationship metaphors of the relationship metaphor dimension, and
tagging one or more of the correlated steps with the attributes of the framework.

15. The method of claim 14, further comprising employing a data mapping step, including linking one or more assemblage types specified by the decision mapping step to situation environment data sources to generate an integrated data model.

16. The method of claim 15, further comprising:
employing a solution mapping step, including,
linking one or more of steps of the decision mapping steps to a layout type of the layout type dimension and to one or more of the assemblage types linked by the data mapping step,
incorporating at least one of the linked assemblage types and one or more additional assemblages into a solution asset set,
incorporating the integrated data model, and
linking the assemblages of the solution asset set into a solution application corresponding to the software application specification.

17. The method of claim 16, wherein the solution Application comprises a set of linked assemblages resulting from application of the decision mapping step and the data mapping step.

18. The method of claim 1, wherein the method is implemented with a computer system including one or more hardware and/or software components.

19. The method claim 1, wherein the method is implemented via one or more computer readable instructions embedded on a computer readable medium and configured to cause one or more computer processors to perform the steps of the method.

20. A method for displaying information, the method comprising:
displaying one or more graphical elements corresponding to first and second feature sets; and
employing in a consistent manner the displaying of the one or more graphical elements to represent information in a form useful for at least one of decision-making, and problem-solving,
wherein the first feature set is based on one of a matrix, a list, a collection, a curve, a timeflow, a sequence flow, a relationship, a map, a stack, and a control, and
the second feature is based on one of a situation of interest, a goal, a plan, a comparison, an evaluation, a conceptual aid, a qualifier, an action, an alert, and an alarm.

21. The method of claim 20, wherein the employing step includes representing a same or similar graphical element or relationship of graphical elements across multiple views or view states.

22. The method of claim 20, wherein the method is implemented with a computer system including one or more hardware and/or software components.

23. The method claim 20, wherein the method is implemented via one or more computer readable instructions embedded on a computer readable medium and configured to cause one or more computer processors to perform the steps of the method.
